(19) United States
(12) Patent Application Publication
(10) Pub. No.: US 2023/0096033 A1
(43) Pub. Date: Mar. 30, 2023

(54) Lithium-Ion Battery Containing a Stable Artificial Solid-Electrolyte Interface Layer

(71) Applicant: Global Graphene Group, Inc., Dayton, OH (US)

(72) Inventor: Bor Z. Jang, Centerville, OH (US)

(21) Appl. No.: 17/449,002

(22) Filed: Sep. 27, 2021

(51) Int. Cl. H01M 10/0562; H01M 10/0525

(52) U.S. Cl. CPC H01M 10/0562; H01M 10/0525; H01M 2300/0071; H01M 2004/027

(57) ABSTRACT

A lithium-ion battery comprising an anode, a cathode, a lithium-ion permeable and electrically insulating separator that electrically separates the anode from the cathode, and an artificial solid-electrolyte interface (SEI) layer disposed between the anode and the separator wherein (a) the artificial SEI layer has a lithium-ion conductivity greater than 10⁻⁶ S/cm and (b) the anode comprises (i) multiple particles of an anode active material selected from the group consisting of silicon (Si), germanium (Ge), phosphorus (P), tin (Sn), lead (Pb), antimony (Sb), bismuth (Bi), zinc (Zn), aluminum (Al), titanium (Ti), nickel (Ni), cobalt (Co), cadmium (Cd), alloys thereof, alloys thereof with lithium (Li), and combinations thereof; (ii) 0-10% (preferably 0.1%-5%) by weight of a conductive additive; and (iii) 0-10% (preferably 0-5%) by weight of a binder resin. Also provided is a method of producing such a battery.

### FIELD

The present disclosure provides a stable solid-electrolyte interface layer for a high-energy lithium-ion cell.

### BACKGROUND

A unit cell or building block of a lithium-ion battery is typically composed of an anode current collector, an anode or negative electrode layer (also known as an anode active material layer typically containing an anode active material responsible for storing lithium therein, a conductive additive, and a resin binder) supported on the anode current collector, an electrolyte and porous separator, a cathode or positive electrode layer (containing a cathode active material responsible for storing lithium therein, a conductive additive, and a resin binder), and a separate cathode current collector supporting the cathode layer. The electrolyte is in ionic contact with both the anode active material and the cathode active material. A porous separator is not required if the electrolyte is a solid-state electrolyte or if the separator itself is a solid-state electrolyte.

The binder in the anode layer is used to bond the anode active material (e.g., graphite or Si particles) and a conductive filler (e.g., carbon black or carbon nanotube) together to form an anode layer of structural integrity, and to bond the anode layer to an anode current collector, which acts to collect electrons from the anode active material when the battery is discharged. In other words, in the negative electrode (anode) side of the battery, there are typically four different materials involved: an anode active material, a conductive additive, a resin binder (e.g., polyvinylidine fluoride, PVDF, or styrene-butadiene rubber, SBR), and an anode current collector (typically a sheet of Cu foil). Typically, the former three materials form a separate, discrete anode active material layer that is bonded to the latter one (Cu foil). In some cases, a Cu foil can be deposited with two anode active material layers on the two primary surfaces of the Cu foil.

The most commonly used anode active materials for lithium-ion batteries are natural graphite and synthetic graphite (or artificial graphite) that can be intercalated with lithium and the resulting graphite intercalation compound may be expressed as LiₓC₆, where x is typically less than 1. The maximum amount of lithium that can be reversibly intercalated into the interstices between graphene planes of a perfect graphite crystal corresponds to x=1, defining a theoretical specific capacity of 372 mAh/g.

Graphite or carbon anodes can have a long cycle life due to the presence of a protective solid-electrolyte interface layer (SEI), which results from the reaction between lithium and the electrolyte (or between lithium and the anode surface/edge atoms or functional groups) during the first several charge-discharge cycles. The lithium in this reaction comes from some of the lithium ions originally intended for the purpose of the charge transfer between an anode and a cathode. As the SEI is formed, the lithium ions become part of the inert SEI layer and become irreversible, i.e., these positive ions can no longer be shuttled back and forth between the anode and the cathode during subsequent charges/discharges. Therefore, it is desirable to use a minimum amount of lithium for the formation of an effective SEI layer. In addition to SEI formation, the irreversible capacity loss Qᵢᵣ can also be attributed to graphite exfoliation caused by electrolyte/solvent co-intercalation and other side reactions.

In addition to carbon- or graphite-based anode materials, other inorganic materials that have been evaluated for potential anode applications include metal oxides, metal nitrides, metal sulfides, and the like, and a range of metals, metal alloys, and intermetallic compounds that can accommodate lithium atoms/ions or react with lithium. Among these materials, lithium alloys having a composition formula of LiₐA (A is a metal or semiconductor element, such as Al and Si, and “a” satisfies 0<a≤5) are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as schematically illustrated in FIG. 2(A), in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.

To overcome the problems associated with such mechanical degradation, three technical approaches have been proposed:
(1) reducing the size of the active material particle, presumably for the purpose of reducing the total strain energy that can be stored in a particle, which is a driving force for crack formation in the particle. However, a reduced particle size implies a higher surface area available for potentially reacting with the liquid electrolyte to form a higher amount of SEI. Such a reaction is undesirable since it is a source of irreversible capacity loss.
(2) depositing the electrode active material in a thin film form directly onto a current collector, such as a copper foil. However, such a thin film structure with an extremely small thickness-direction dimension (typically much smaller than 500 nm, often necessarily thinner than 100 nm) implies that only a small amount of active material can be incorporated in an electrode (given the same electrode or current collector surface area), providing a low total lithium storage capacity and low lithium storage capacity per unit electrode surface area (even though the capacity per unit mass can be large). Such a thin film should have a thickness less than 100 nm to be more resistant to cycling-induced cracking, further diminishing the total lithium storage capacity and the lithium storage capacity per unit electrode surface area. Such a thin-film battery has very limited scope of application. A desirable and typical electrode thickness is from 100 μm to 200 μm. These thin-film electrodes (with a thickness of <500 nm or even <100 nm) fall short of the required thickness by three (3) orders of magnitude, not just by a factor of 3.
(3) using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nano particles. Presumably, the protective matrix provides a cushioning effect for particle expansion or shrinkage, and prevents the electrolyte from contacting and reacting with the electrode active material. Examples of high-capacity anode active particles are Si, Sn, and SnO₂. Unfortunately, when an active material particle, such as Si particle, expands (e.g. up to a volume expansion of 380%) during the battery charge step, the protective coating is easily broken due to the mechanical weakness and/o brittleness of the protective coating materials. There has been no high-strength and high-toughness material available that is itself also lithium ion conductive.

The prior art protective materials all fall short of these requirements. Hence, it is not surprising to observe that the resulting anode typically shows a reversible specific capacity much lower than expected. In many cases, the first-cycle efficiency is extremely low (mostly lower than 80% and some even lower than 60%). Furthermore, in most cases, the electrode was not capable of operating for a large number of cycles. Additionally, most of these electrodes are not high-rate capable, exhibiting unacceptably low capacity at a high discharge rate.

Due to these and other reasons, most of prior art composite electrodes and electrode active materials have deficiencies in some ways, e.g., in most cases, less than satisfactory reversible capacity, poor cycling stability, high irreversible capacity, ineffectiveness in reducing the internal stress or strain during the lithium ion insertion and extraction steps, and other undesirable side effects.

Complex composite particles of particular interest are a mixture of separate Si and graphite particles dispersed in a carbon matrix; e.g. those prepared by Mao, et al. [“Carbon-coated Silicon Particle Powder as the Anode Material for Lithium Batteries and the Method of Making the Same,” US 2005/0136330 (Jun. 23, 2005)]. Also of interest are carbon matrix-containing complex nano Si (protected by oxide) and graphite particles dispersed therein, and carbon-coated Si particles distributed on a surface of graphite particles Again, these complex composite particles led to a low specific capacity or for up to a small number of cycles only. It appears that carbon by itself is relatively weak and brittle and the presence of micron-sized graphite particles does not improve the mechanical integrity of carbon since graphite particles are themselves relatively weak. Graphite was used in these cases presumably for the purpose of improving the electrical conductivity of the anode material. Furthermore, polymeric carbon, amorphous carbon, or pre-graphitic carbon may have too many lithium-trapping sites that irreversibly capture lithium during the first few cycles, resulting in excessive irreversibility.

However, the electrolytes used for lithium-ion batteries and all lithium metal secondary batteries pose some safety concerns. Most of the organic liquid electrolytes can cause thermal runaway or explosion problems. Solid state electrolytes are commonly believed to be safe in terms of fire and explosion resistance. Solid state electrolytes can be divided into organic, inorganic, organic-inorganic composite electrolytes.

All-solid-state batteries are believed to be capable of realizing ultimate safety and superior energy density. The use of solid electrolytes is essential to enabling such outstanding features, instead of liquid electrolytes employed in conventional lithium-ion batteries. In this regard, the development of solid electrolytes with superior electrochemical properties is highly desirable.

The solid electrolyte is normally utilized in two parts in the all-solid-state batteries. First, the separator layer between the cathode and the anode is fabricated from particles of a solid electrolyte powder for providing efficient lithium-ion transport between the two electrodes while electrically isolating the anode and the cathode. This solid-electrolyte separator is typically prepared by cold-pressing of solid electrolyte particles with/without polymeric binder/scaffold or by sintering of solid electrolyte particles in close contact at high temperature. Second, the solid electrolyte is mixed with an anode active material to form a composite electrode, essentially mimicking the porous electrode in lithium-ion batteries that use liquid electrolyte. In conventional lithium-ion batteries, a liquid electrolyte permeates and fills the pores within an electrode, thereby facilitating the lithium-ion transport within the electrode. However, this is difficult to realize in the all-solid-state batteries. Thus, for the production of an all-solid-state electrode, ionic transport media should be established to facilitate facile ion migration to the active material. In this context, an efficient spatial arrangement of the solid electrolyte within the electrode is vital, and various stringent mixing protocols and intricate particle size control of solid electrolytes/active materials should be followed.

Unfortunately, previous approaches to incorporating a solid-state electrolyte into an electrode (an anode or a cathode) typically have resulted in a low proportion of the anode or cathode active material (e.g., up to only 50-75% by weight or by volume of the anode or cathode active material) and, hence, a low charge storage capacity of the battery per unit weight or volume. Since the electrolyte, the binder resin, and the conductive additive are electrochemically inactive materials (i.e., they are not capable of storing lithium), their proportion should be reduced or minimized. Furthermore, not much work in the battery industry has been conducted on the compatibility or interactions between solid-state electrolytes and high-capacity anode active materials (e.g., Si, Ge, Sn, Al, P, SiO, SnO₂, etc.). In particular, how the solid-state electrolyte can handle the large volume changes of these anode active materials remain largely unknown.

Hence, a general object of the present disclosure is to provide a stable artificial solid-liquid interface (SEI) layer and a safe, flame/fire-resistant, solid-state lithium ion-transporting electrolyte that replaces the conventional electrolyte for a lithium-ion cell capable of storing a higher amount of charge per unit battery weight or volume. A specific object of the disclosure is to provide a lithium-ion cell that does not exhibit a rapid capacity decay issue caused by the large volume changes of the high-capacity anode active materials. Such a battery cell should also have a high rate capability, capable of delivering a high energy even at a relatively high charge/discharge rate. Such a battery cell should also be compatible with existing battery production processes and equipment.

### SUMMARY

The present disclosure provides a lithium-ion battery comprising an anode (or anode active material layer), a cathode (or cathode active material layer), a lithium-ion permeable and electrically insulating separator (e.g., a porous polymer membrane or a layer of solid-state electrolyte) that electrically separates the anode from the cathode, and an artificial solid-electrolyte interface (SEI) layer disposed between the anode and the separator wherein (a) the artificial SEI layer has a lithium-ion conductivity greater than 10⁻⁶ S/cm and (b) the anode comprises (i) multiple particles of an anode active material selected from the group consisting of silicon (Si), germanium (Ge), phosphorus (P), tin (Sn), lead (Pb), antimony (Sb), bismuth (Bi), zinc (Zn), aluminum (Al), titanium (Ti), nickel (Ni), cobalt (Co), cadmium (Cd), alloys thereof, alloys thereof with lithium (Li), and combinations thereof; (ii) 0-10% by weight of a conductive additive; and (iii) 0-10% by weight of a binder resin. Preferably, the artificial SEI layer has a lithium-ion conductivity from 10⁻⁵ S/cm to 10⁻² S/cm. Preferably, the anode contains multiple pores having a pore volume (porosity level) of 10%-75% based on the total anode volume to accommodate the volume expansion of the anode active material particles when the battery is charged.

In certain embodiments, the artificial SEI layer comprises a lithium- or sodium-containing species selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, Na₂CO₃, Na₂O, Na₂C₂O₄, NaOH, NaiX, ROCO₂Na, HCONa, RONa, (ROCO₂Na)₂, (CH₂OCO₂Na)₂, Na₂S, NaₓSO_{y}, or a combination thereof, wherein X=F, Cl, I, or Br, R=a hydrocarbon group, x=0-1, y=1-4. The lithium- or sodium-containing species may be derived from an electrochemical decomposition reaction that is intentionally induced inside an intended battery cell or external to an intended battery cell. The artificial SEI layer may be bonded to the anode layer, to the separator or solid-state electrolyte, or to both.

In some specific embodiments, the artificial SEI layer comprises a matrix of amorphous carbon, polymeric carbon, or a polymer, and from 0% to 50% by weight of a reinforcement phase dispersed in the matrix, and a lithium- or sodium-containing species that are chemically bonded to or dispersed in the matrix and/or the optional reinforcement phase to form an integral layer, wherein the lithium- or sodium-containing species is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, Na₂CO₃, Na₂O, Na₂C₂O₄, NaOH, NaiX, ROCO₂Na, HCONa, RONa, (ROCO₂Na)₂, (CH₂OCO₂Na)₂, NaS, NaₓSO_{y}, or a combination thereof, wherein X=F, Cl, I, or Br, R=a hydrocarbon group, x=0-1, y=1-4. In some embodiments, the lithium- or sodium-containing species is derived from an electrochemical decomposition reaction, wherein the matrix is from 5% to 95% by volume of the integral layer if the reinforcement phase is present, and wherein a weight ratio of the matrix to the lithium- or sodium-containing species is from 1/100 to 100/1.

In some embodiments, the artificial SEI layer comprises a product of electrochemical reductive or oxidative degradation of an electrolyte. Such a product typically does not contain Si.

The matrix (carbon matrix, polymeric carbon matrix, or polymer matrix) can be present alone without any reinforcement phase or filler (i.e., 100% matrix). If a reinforcement phase and/or a filler is present (dispersed in the matrix), then the amorphous carbon or polymeric carbon matrix and the reinforcement phase and/or the filler form a carbon matrix composite, for instance, wherein the matrix is preferably from 5% to 95% by volume (preferably from 20% to 80% by volume and more preferably from 30% to 70% by volume). The weight ratio of the carbon matrix to the lithium- or sodium-containing species can be varied from 1/100 to 100/1 (preferably from 1/20 to 20/1 and more preferably from 1/10 to 10/1).

This artificial SEI layer is disposed between an anode active material layer (e.g., a sheet of Si or Sn particles, with or without a binder resin and/or a conductive additive) and a porous separator layer wetted by a liquid or gel electrolyte (or a solid-state electrolyte layer if the porous separator layer is not present). Preferably, the anode active material layer (also simply referred to as an anode active layer or anode layer) preferably contains no electrolyte therein that can otherwise continue to form undesirable SEI on surfaces of individual anode active material particles caused by electrochemical reactions between the electrolyte and the anode active material.

The carbon or graphite reinforcement phase contains a material selected from ceramic particles or fibers, glass particles or fibers, soft carbon particles, hard carbon particles, expanded graphite flakes, carbon black particles, carbon nanotubes, carbon nano-fibers, carbon fibers, graphite fibers, polymer fibers, coke particles, meso-phase carbon particles, meso-porous carbon particles, electro-spun conductive nano fibers, carbon-coated metal nanowires, conductive polymer-coated nanowires or nano-fibers, graphene sheets or platelets, or a combination thereof. This carbon or graphite reinforcement phase is used to strengthen the matrix (amorphous carbon, polymeric carbon, or polymer matrix) which otherwise can be relatively weak. The matrix is permeable to lithium ions. The reinforcement phase is normally not permeable to lithium ions unless this graphite material is intentionally made to contain defects (e.g., point defects, missing bonds, pores, etc.). Thus, a carbon matrix containing a dispersed carbon/graphite reinforced phase makes an ideal layer that, on one hand, provides structural integrity to the SEI layer and, on the other hand, allows lithium ions to migrate through, which is required for the battery to operate.

These lithium- or sodium-containing species are capable of bonding with the carbon matrix and the carbon/graphite reinforcement phase to form a structurally sound layer. Yet, such a layer is permeable to lithium ions. Preferably and typically, this layer is electronically insulating, but ionically lithium ion-conducting.

The reinforcement phase may contain graphene sheets or platelets including single-layer sheets or multi-layer platelets of a graphene material selected from pristine graphene, graphene oxide having 2% to 46% by weight of oxygen, reduced graphene oxide having 0.01% to 2% by weight of oxygen, chemically functionalized graphene, nitrogen-doped graphene, boron-doped graphene, fluorinated graphene, or a combination thereof and these graphene sheets or platelets are preferably interconnected (overlapped with one another). The graphene sheets or platelets preferably have a thickness less than 10 nm. Preferably, the graphene sheets or platelets contain single-layer or few-layer graphene, wherein few-layer is defined as 10 planes of hexagonal carbon atoms or less.

The amorphous carbon or polymeric carbon matrix is preferably obtained by sputtering of carbon, chemical vapor deposition, chemical vapor infiltration, or pyrolization of a polymer or pitch material onto a solid substrate (e.g., a separator or solid-state electrolyte layer).

In addition to or as an alternative to the carbon/graphite reinforcement phase, a filler (multiple particles) may be dispersed in the amorphous carbon or polymeric carbon matrix. The filler may be selected from a metal oxide, metal carbide, metal nitride, metal boride, metal dichalcogenide, or a combination thereof. In an embodiment, the filler is selected from an oxide, dichalcogenide, trichalcogenide, sulfide, selenide, or telluride of niobium, zirconium, molybdenum, hafnium, tantalum, tungsten, titanium, vanadium, chromium, cobalt, manganese, iron, or nickel in a nanowire, nano-disc, nano-ribbon, or nano platelet form.

In a preferred embodiment, the filler is selected from nano discs, nano platelets, or nano sheets of an inorganic material selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof; wherein the discs, platelets, or sheets have a thickness less than 100 nm. These 2D nano materials are found to be very effective in stopping dendrite penetration; however, they are normally not very permeable to lithium ions or sodium ions. Hence, they should be dispersed in a carbon matrix that is permeable to lithium or sodium ions.

The conductive additive, if present, may contain a material selected from carbon particles, expanded graphite flakes, carbon black particles, carbon nanotubes, carbon nano-fibers, carbon fibers, graphite fibers, conductive polymer fibers, coke particles, meso-phase carbon particles, meso-porous carbon particles, electro-spun nano fibers, carbon-coated metal nanowires, conductive polymer-coated nanowires or nano-fibers, graphene sheets or platelets, or a combination thereof. Preferably, the conductive additive occupies 0%-5% by weight of the anode active layer, more preferably 0.1% to 3%.

There is no restriction on the type of a binder resin that can be used to bond anode active material particles together if a binder resin is desired (typically 0% to 5% by weight of a binder resin in the anode active layer. It may be desirable to use a resin binder to bond the anode active layer to an anode current collector (e.g., a Cu foil, Ni foil, stainless steel foil, etc.).

There is no restriction on the thickness of the artificial SEI layer, but for practical purposes, the layer preferably has a thickness from 10 nm to 20 μm, more preferably from 100 nm to 10 μm, and most preferably from 100 nm to 5 μm. In one preferred embodiment, the artificial SEI layer is a lithium ion conductor having an ion conductivity no less than 10⁻⁴ S/cm, more preferably no less than 10⁻³ S/cm.

In certain embodiments, the separator comprises a porous polymer or polymer membrane, a fabric, a solid polymer electrolyte, an inorganic solid electrolyte, or a combination thereof.

The inorganic solid electrolyte may be selected from an oxide type, Perovskite, sulfide type, argyrodite, hydride type, halide type, borate type, phosphate type, lithium phosphorus oxynitride (UPON), garnet-type, lithium superionic conductor (LISICON) type, sodium superionic conductor (NASICON) type, or a combination thereof.

The solid polymer electrolyte may be selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

Preferably, the porous polymer membrane separator or the solid polymer electrolyte is further soaked or impregnated with a liquid electrolyte comprising a lithium salt dissolved in a liquid solvent.

The present disclosure also provides a method or process for producing such an artificial SEI layer. The method or process comprises: (a) preparing a working electrode containing a structure (e.g., porous or solid sheet) of an amorphous carbon, polymeric carbon, or polymer matrix and an optional reinforcement phase dispersed in the matrix; (b) preparing a counter electrode containing lithium or sodium metal or alloy; (c) bringing the working electrode and the counter electrode in contact with an electrolyte containing a solvent and a lithium salt or sodium salt dissolved in the solvent; and (d) applying a current or voltage to the working electrode and the counter electrode (disposed in an electrochemical reactor) to induce an electrochemical oxidative decomposition and/or a reductive decomposition of the electrolyte and/or the salt for forming the lithium- or sodium-containing species that are chemically bonded to the matrix and/or the optional reinforcement phase to produce the artificial SEI layer.

The electrochemical decomposition treatment may be carried out in a roll-to-roll manner. In an embodiment, the continuous-length layer of carbon nanotube/graphene-reinforced carbon composite structure (e.g., CNT/graphene paper infiltrated with CVD carbon) may be unwound from a feeder roller, and moved to enter an electrochemical treatment zone (equivalent to an electrochemical decomposition reactor) containing an electrolyte therein. Immersed in this electrolyte is a lithium or sodium electrode and the graphene paper is also electrically wired as the working electrode. The carbon-infiltrated CNT/graphene paper is moved at a controlled speed to give enough time for electrochemical decomposition of the electrolyte to occur. The paper is impregnated with and/or bonded by the decomposition products and the product is then wound up on a take-up roller. This roll-to-roll or reel-to-reel process can be easily scaled up and automated for mass production of the presently invented dendrite penetration resistant layer products.

In other words, in an embodiment, the process is a roll-to-roll process that includes preparing the working electrode in a roll form supported by a roller, and the step of bringing the working electrode and the counter electrode in contact with the electrolyte contains unwinding the working electrode from the roller, and feeding the working electrode into the electrolyte.

In an alternative embodiment, a sheet of carbon matrix composite paper may be unwound from a feeder roller, deposited with some lithium or sodium metal (e.g., using physical vapor deposition or sputtering) while the paper is in a dry state. The Li- or Na-deposited carbon matrix composite paper is then moved to enter an electrochemical treatment zone containing an electrolyte therein. As soon as the Li-carbon composite layer or Na-carbon composite layer enters the electrolyte, essentially short-circuiting occurs between the carbon composite and Li (or Na). In other words, the carbon composite “electrode” is essentially placed in an electrochemical potential that is 0 V with respect to Li⁺/Li or Na⁺/Na, subjecting the electrolyte to a reductive decomposition and enabling decomposition products to react with the carbon matrix composite in situ. Optionally a lithium or sodium electrode is implemented and immersed in this electrolyte and the carbon composite paper is electrically wired as the working electrode. Such an arrangement aids in continuing electrochemical decomposition of electrolytes and formation of the bonding Li- or Na-containing species. The carbon matrix composite is impregnated with and/or bonded by the decomposition products, which product is then wound up on a take-up roller.

Thus, an alternative embodiment of the method or process for producing the artificial SEI layer comprises (a) preparing a working electrode containing a layer of the carbon matrix or carbon matrix composite; (b) preparing a counter electrode containing lithium or sodium metal or alloy; and (c) bringing the working electrode and the counter electrode in physical contact with each other and in contact with an electrolyte containing a solvent and a lithium salt or sodium salt dissolved in the solvent; wherein the working electrode and the counter electrode are brought to be at the same electrochemical potential level, inducing a chemical reaction between the lithium/sodium metal or alloy and the carbon matrix or carbon matrix composite, and inducing electrochemical decomposition of the electrolyte for forming the lithium- or sodium-containing species that are chemically bonded to the carbon matrix and/or the reinforcement phase to produce the artificial SEI layer either outside of or inside an intended lithium-ion battery. In an embodiment, this process is conducted in a roll-to-roll manner outside of the intended rechargeable alkali metal battery. Alternatively, this process is conducted inside the intended lithium-ion battery; the battery itself is regarded as an electrochemical decomposition reactor.

The present disclosure also provides a method of producing a lithium-ion battery featuring an artificial SEI layer. This method comprises:
(a) preparing a lithium-ion battery cell comprising (i) an anode layer, (ii) a precursor or supporting layer comprising sulfide, hydride, halide, borate, phosphate, amorphous carbon, polymeric carbon, or a polymer matrix, (iii) a solid-state electrolyte, different in composition than the precursor or supporting layer, or a porous separator layer and a second electrolyte, and (iv) a cathode layer, wherein the precursor or supporting layer of sulfide, hydride, halide, borate, phosphate, amorphous carbon, polymeric carbon, or polymer matrix is laminated between the anode layer and the porous separator or solid-state electrolyte layer, and the porous separator or solid-state electrolyte layer is disposed between the precursor or supporting layer and the cathode layer; and
(b) subjecting the battery cell to a voltage/current treatment that induces electrochemical reductive and/or oxidative decomposition of the solid-state electrolyte, the second electrolyte, the sulfide, hydride, halide, borate, or phosphate to form the lithium- and/or sodium-containing species that are chemically bonded to the amorphous carbon, polymeric carbon, or polymer matrix or bonded to the anode, the solid-state electrolyte, or the separator layer to form the artificial SEI layer in the battery cell. The voltage/current treatment may include subjecting the solid-state electrolyte, the second electrolyte, the sulfide, hydride, halide, borate, phosphate, or a combination thereof to an electrochemical potential beyond a thermodynamically stable region for these materials.

In certain embodiments, step (a) of preparing a lithium-ion battery cell comprises depositing sulfide, hydride, halide, borate, amorphous carbon, polymeric carbon, or a polymer matrix onto the anode layer or the porous separator or the solid-state electrolyte layer to form a layer up to a thickness from 10 nm to 20 μm.

There is no particular restriction on the type of cathode active materials that can be used in the presently disclosed lithium-ion battery. The cathode materials can be inorganic, organic, polymeric materials, or a combination thereof. The cathode active material preferably comprises an inorganic material selected from a metal oxide, metal phosphate, metal silicide, metal selenide, transition metal sulfide, or a combination thereof. The inorganic material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

In certain preferred embodiments, the cathode active material is selected from lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₅), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

The lithium-ion cell may further comprise a cathode current collector selected from aluminum foil, carbon- or graphene-coated aluminum foil, stainless steel foil or web, carbon- or graphene-coated steel foil or web, carbon or graphite paper, carbon or graphite fiber fabric, flexible graphite foil, graphene paper or film, or a combination thereof. A web means a screen-like structure or a metal foam, preferably having interconnected pores or through-thickness apertures.

The second electrolyte or the electrolyte to be introduced in the cathode of the intended lithium-ion battery may be selected from polymer electrolyte, polymer gel electrolyte, composite electrolyte, ionic liquid electrolyte, non-aqueous liquid electrolyte, soft matter phase electrolyte, inorganic solid-state electrolyte, or a combination thereof.

The advantages and features of the present disclosure will become more transparent with the description of the following best mode practice and illustrative examples.

### BRIEF DESCRIPTION OF THE DRAWINGS

FIG. 1 Schematic of a lithium-ion battery featuring an artificial SEI layer implemented between an anode layer and a porous separator layer or solid-state electrolyte separator.

FIG. 2(A) Schematic illustrating the notion that expansion of Si particles, upon lithium intercalation during charging of a prior art lithium-ion battery, can lead to pulverization of Si particles, interruption of the conductive paths formed by the conductive additive, and loss of contact with the current collector;

FIG. 2(B) illustrates the issues associated with the prior art anode active material; for instance, a non-lithiated Si particle encapsulated by a protective shell (e.g., carbon shell) in a core-shell structure inevitably leads to breakage of the shell and that a pre-lithiated Si particle encapsulated with a protective layer leads to poor contact between the contracted Si particle and the rigid protective shell during battery discharge.

FIG. 3 An energy diagram to illustrate electrochemical potential or energetic conditions under which electrolyte in an electrochemical reactor undergoes oxidative or reductive degradation at the electrode-electrolyte boundary.

FIG. 4(A) Schematic of a process for producing an artificial SEI, according to some embodiments of the present disclosure;

FIG. 4(B) Schematic of a process for producing a high-energy density lithium-ion battery featuring an artificial SEI disposed between an anode and a separator, according to some embodiments of the present disclosure.

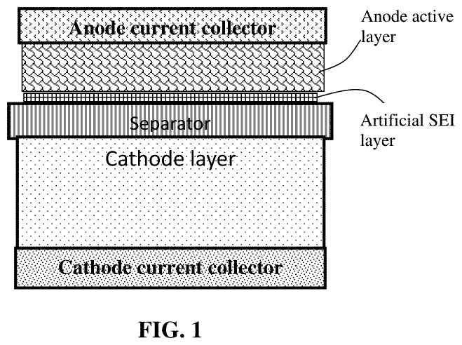

### DETAILED DESCRIPTION

A lithium-ion battery cell is typically composed of an anode current collector (e.g., Cu foil), an anode or negative electrode active material layer (i.e. anode layer typically containing particles of an anode active material, conductive additive, and binder), a porous separator and/or an electrolyte component, a cathode or positive electrode active material layer (containing a cathode active material, conductive additive, and resin binder), and a cathode current collector (e.g. Al foil). More specifically, the anode layer is composed of particles of an anode active material (e.g. graphite, Sn, SnO₂, Si, or SiOₓ, where 0<x<2), a conductive additive (e.g. carbon black particles), and a resin binder (e.g. SBR or PVDF). This anode layer is typically 50-300 μm thick (more typically 100-200 μm) to give rise to a sufficient amount of current per unit electrode area.

The anode current collector may be coated with one anode active material layer on one primary surface or two anode active material layers on the two primary surfaces of a current collector. The term “anode” or “negative electrode” refers to the laminate composed of a current collector and one or two anode active material layers bonded thereto. The term anode can refer to an anode active material layer, particularly if there is no anode current collector.

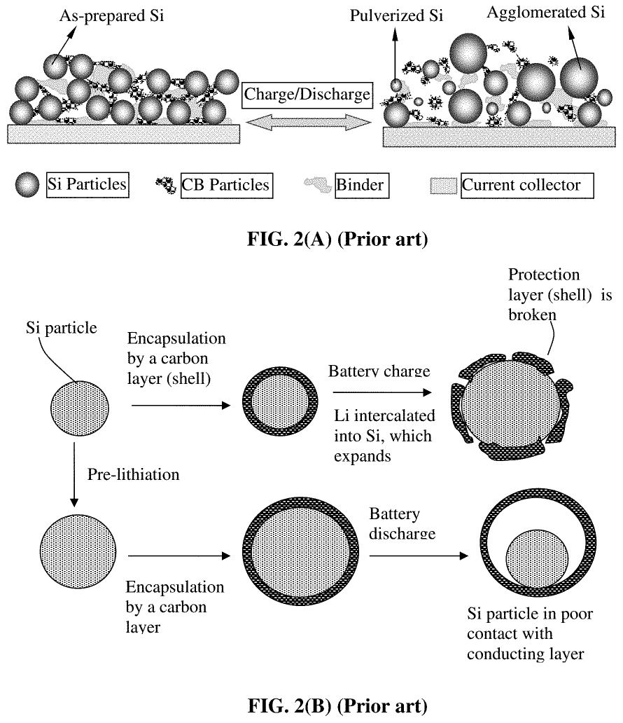

In order to obtain a higher energy density cell, the anode can be designed to contain higher-capacity anode active materials having a composition formula of LiₐA (A is a metal or semiconductor element, such as Al and Si, and “a” satisfies 0<a≤5). These materials are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li3Sb (660 mAh/g), Li_{4.4}Pb (569 mAh/g), LiZn (410 mAh/g), and Li₃Bi (385 mAh/g). Each and every one of these anode active materials has a maximum lithium ion or charge storage capacity (e.g., 1,623 mAh/g for Ge). However, as discussed in the Background section, there are several problems associated with the implementation of these high-capacity anode active materials:
1) As schematically illustrated in FIG. 2(A), in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.
2) The approach of using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nano particles, has failed to overcome the capacity decay problem. Presumably, the protective matrix provides a constraining effect for particle expansion or shrinkage, and prevents the electrolyte from contacting and reacting with the electrode active material. Unfortunately, when an active material particle, such as Si particle, expands (e.g. up to a volume expansion of 380%) during the battery charge step, the protective coating is easily broken due to the mechanical weakness and/or brittleness of the protective coating materials. There has been no high-strength and high-toughness material available that is itself also lithium ion conductive.
3) The approach of using a core-shell structure (e.g., Si nano particle encapsulated in a carbon or SiO₂ shell) also has not solved the capacity decay issue. As illustrated in upper portion of FIG. 2(B), a non-lithiated Si particle can be encapsulated by a carbon shell to form a core-shell structure (Si core and carbon or SiO₂ shell in this example). As the lithium-ion battery is charged, the anode active material (carbon- or SiO₂-encapsulated Si particle) is intercalated with lithium ions and, hence, the Si particle expands. Due to the brittleness of the encapsulating shell (carbon), the shell is broken into segments, exposing the underlying Si to electrolyte and subjecting the Si to undesirable reactions with electrolyte during repeated charges/discharges of the battery. These reactions continue to consume the electrolyte and reduce the cell's ability to store lithium ions.
4) Referring to the lower portion of FIG. 2(B), wherein the Si particle has been pre-lithiated with lithium ions; i.e. has been pre-expanded in volume. When a layer of carbon (as an example of a protective material) is encapsulated around the pre-lithiated Si particle, another core-shell structure is formed. However, when the battery is discharged and lithium ions are released (de-intercalated) from the Si particle, the Si particle contracts, leaving behind a large gap between the protective shell and the Si particle. Such a configuration is not conducive to lithium intercalation of the Si particle during the subsequent battery charge cycle due to the gap and the poor contact of Si particle with the protective shell (through which lithium ions can diffuse). This would significantly curtail the lithium storage capacity of the Si particle particularly under high charge rate conditions.

In other words, there are several conflicting factors that should be considered concurrently when it comes to the design and selection of an anode active material in terms of material type, shape, size, porosity, electrode layer thickness, anode binder, and anode material prelithiation. Conventional strategies for protecting the anode particles or the anode electrode have also fallen short of addressing the rapid cycle decay issues. Thus far, there has been no effective solution offered by any prior art teaching to these conflicting problems. We have solved these challenging issues that have troubled battery designers and electrochemists alike for more than 30 years by developing the approach of combining an artificial solid-electrolyte interface (SEI) with a solid-state electrolyte protected and by implementing this combination between an anode active material layer and a cathode active material layer. The approach is further augmented by eliminating electrolyte (liquid or solid) and reducing the binder content from the anode active material layer to increase the anode active material proportion, hence achieving a high energy density.

The present disclosure provides a lithium-ion battery comprising an anode (or anode active material layer), a cathode (or cathode active material layer), a lithium-ion permeable and electrically insulating separator (e.g., a porous polymer membrane or a layer of solid-state electrolyte) that electrically separates the anode from the cathode, and an artificial solid-electrolyte interface (SEI) layer disposed between the anode and the separator wherein (a) the artificial SEI layer has a lithium-ion conductivity greater than 10⁻⁶ S/cm and (b) the anode comprises (i) multiple particles of an anode active material selected from the group consisting of silicon (Si), germanium (Ge), phosphorus (P), tin (Sn), lead (Pb), antimony (Sb), bismuth (Bi), zinc (Zn), aluminum (Al), titanium (Ti), nickel (Ni), cobalt (Co), cadmium (Cd), alloys thereof, alloys thereof with lithium (Li), and combinations thereof; (ii) 0-10% by weight of a conductive additive; and (iii) 0-10% by weight of a binder resin. Preferably, the artificial SEI layer has a lithium-ion conductivity from 10⁻⁵ S/cm to 10⁻² S/cm. Preferably, the anode contains multiple pores having a pore volume (porosity level) of 10%-75% based on the total anode volume to accommodate the volume expansion of the anode active material particles when the battery is charged.

In certain embodiments, the artificial SEI layer comprises a lithium- or sodium-containing species selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, Na₂CO₃, Na₂O, Na₂CO₄, NaOH, NaiX, ROCO₂Na, HCONa, RONa, (ROCO₂Na)₂, (CH₂OCO₂Na)₂, Na₂S, NaₓSO_{y}, or a combination thereof, wherein X=F, Cl, I, or Br, R=a hydrocarbon group, x=0-1, y=1-4. The lithium- or sodium-containing species may be derived from an electrochemical decomposition reaction that is intentionally induced inside an intended battery cell or external to an intended battery cell. The artificial SEI layer may be bonded to the anode layer, to the separator or solid-state electrolyte, or to both.

In some specific embodiments, the artificial SEI layer comprises a matrix of amorphous carbon, polymeric carbon, or a polymer, and from 0% to 50% by weight of a reinforcement phase dispersed in the matrix, and a lithium- or sodium-containing species that are chemically bonded to or dispersed in the matrix and/or the optional reinforcement phase to form an integral layer, wherein the lithium- or sodium-containing species is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, Na₂CO₃, Na₂O, Na₂CO₄, NaOH, NaiX, ROCO₂Na, HCONa, RONa, (ROCO₂Na)₂, (CH₂OCO₂Na)₂, Na₂S, NaₓSO_{y}, or a combination thereof, wherein X=F, Cl, I, or Br, R=a hydrocarbon group, x=0-1, y=1-4. In some embodiments, the lithium- or sodium-containing species is derived from an electrochemical decomposition reaction, wherein the matrix is from 5% to 95% by volume of the integral layer if the reinforcement phase is present, and wherein a weight ratio of the matrix to the lithium- or sodium-containing species is from 1/100 to 100/1.

These lithium- or sodium-containing bonding species can be simply the products or by-products of chemical reactions between an electrolyte (Li or Na salt and solvent) and the carbon matrix, the carbon/graphite-based reinforcement phase, and/or the sulfide, hydride, halide, or borate that are induced by externally applied current/voltage in an electrochemical reactor. This will be discussed in more detail later.

In a preferred embodiment, the lithium- or sodium-containing species may be selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, Na₂CO₃, Na₂O, Na₂CO₄, NaOH, NaiX, ROCO₂Na, HCONa, RONa, (ROCO₂Na)₂, (CH₂OCO₂Na)₂, Na₂S, NaₓSO_{y}, or a combination thereof, wherein X=F, Cl, I, or Br, R=a hydrocarbon group (e.g., R═CH—, CH₂—, CH₃CH₂—, etc.), x=0-1, y=1-4. These species are surprisingly capable of bonding a wide variety of carbon/graphite reinforcement materials and/or carbon matrix together to form a structurally sound layer that is sufficiently strong to maintain integrity during the battery charges/discharges. Carbon matrix composite can contain a graphite/carbon reinforcement material selected from multiple sheets/platelets of a graphene material, multiple flakes of exfoliated graphite, carbon nano-fibers, carbon nanotubes, carbon fibers, graphite fibers, carbon black or acetylene black particles, needle coke, soft carbon particles, hard carbon particles, artificial graphite particles. These particle or fibers preferably have a diameter or thickness less than 10 μm, preferably less than 1 μm, further preferably less than 200 nm, and most preferably less than 100 nm. Such a carbon matrix composite layer is also permeable to lithium ions or sodium ions. Preferably, this layer is electronically insulating, but ionically conducting. Typically, not just one, but at least two types of lithium- or sodium-containing species in the above list are present in the dendrite penetration-resistant layer.

In certain embodiments, the inorganic solid electrolyte materials (used as a separator or as an electrolyte in the cathode to form a catholyte) are preferably selected from an oxide type, sulfide type, hydride type, halide type, borate type, phosphate type, lithium phosphorus oxynitride (LiPON), garnet-type, lithium superionic conductor (LISICON) type, sodium superionic conductor (NASICON) type, or a combination thereof.

The inorganic solid electrolytes include, but are not limited to, perovskite-type, NASICON-type, garnet-type and sulfide-type materials. A representative and well-known perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in a polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge, Zr or Ti. In particular, the LiTi₂(PO₄)₃ system has been widely studied as a solid-state electrolyte for the lithium-ion battery. The ionic conductivity of LiZr₂(PO₄)₃ is very low, but can be improved by the substitution of Hf or Sn. This can be further enhanced with substitution to form Li₁₊ₓMₓTi₂₋ₓ(PO₄)₃ (M=Al, Cr, Ga, Fe, Sc, In, Lu, Y or La). Al substitution has been demonstrated to be the most effective solid-state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and sixfold coordination, respectively. In addition to Li₃M₂Ln₃O₁₂ (M=W or Te), a brand series of garnet-type materials may be used as an additive, including Li₅La₃M₂O₁₂ (M=Nb or Ta), Li₆ALa₂M₂O₁₂ (A=Ca, Sr or Ba; M=Nb or Ta), Li_{5.5}La₃M_{1.75}B_{0.25}O₁₂ (M=Nb or Ta; B=In or Zr) and the cubic systems Li₇La₃Zr₂O₁₂ and Li_{7.06}M₃Y_{0.06}Zr_{1.94}O₁₂ (M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The conductivity in this type of material is 6.9×10⁻⁴ S/cm, which was achieved by doping the Li₂S—SiS₂ system with Li₃PO₄. Other sulfide-type solid-state electrolytes can reach a good lithium-ion conductivity close to 10⁻² S/cm. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S−P₂S₅ material is dispersed in an elastic polymer.

These inorganic solid electrolyte (ISE) particles can be sintered or compacted into solid-state separator layers using known methods. The ISE particles may be dispersed in an electrolyte polymer to enhance the lithium ion conductivity of certain polymers that have a lower ion conductivity. Preferably and typically, the polymer electrolyte has a lithium ion conductivity no less than 10⁻⁵ S/cm, more preferably no less than 10⁻⁴ S/cm, further preferably no less than 10⁻³ S/cm, and most preferably no less than 10⁻² S/cm.

The solid polymer electrolyte may be selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxanepoly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

Preferably, the porous polymer membrane separator or the solid polymer electrolyte is further soaked or impregnated with a liquid electrolyte comprising a lithium salt dissolved in a liquid solvent.

The artificial SEI layer may be produced in an apparatus external to an intended lithium-ion battery and before the artificial SEI layer is incorporated into the lithium-ion battery. Alternatively, the artificial SEI layer may be produced in situ inside a lithium-ion battery initially containing a precursor or supporting layer, which is then electrochemically converted into an artificial SEI layer. These two approaches are described further below:

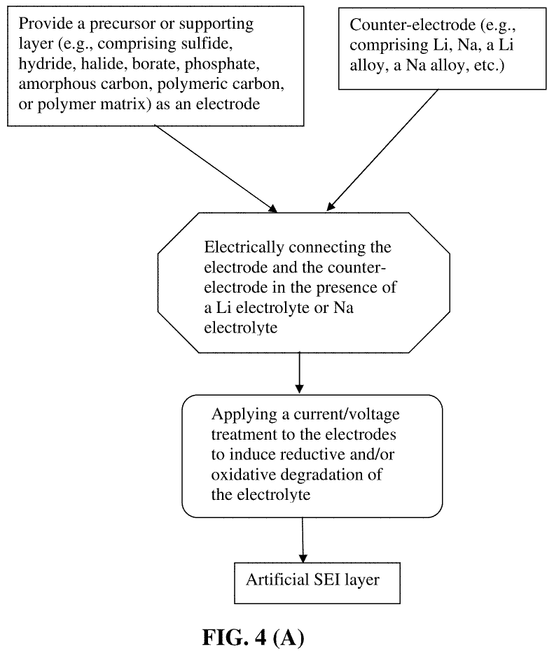

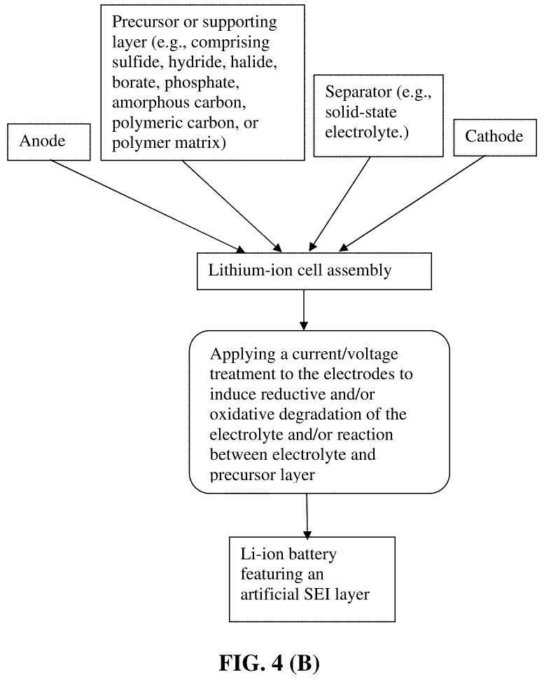

The present disclosure also provides a method or process for producing such an artificial SEI layer. As illustrated in FIG. 4(A), the method or process comprises: (a) preparing a working electrode containing a structure (e.g., porous or solid sheet) of an amorphous carbon, polymeric carbon, or polymer matrix and an optional reinforcement phase dispersed in the matrix; (b) preparing a counter electrode containing lithium or sodium metal or alloy; (c) bringing the working electrode and the counter electrode in contact with an electrolyte containing a solvent and a lithium salt or sodium salt dissolved in the solvent; and (d) applying a current or voltage to the working electrode and the counter electrode (e.g., disposed in an electrochemical reactor) to induce an electrochemical oxidative decomposition and/or a reductive decomposition of the electrolyte and/or the salt for forming the lithium- or sodium-containing species that are chemically bonded to the matrix and/or the optional reinforcement phase to produce the artificial SEI layer.

The lithium salt or sodium salt in this electrochemical decomposition reactor is selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethylsulfonylimide (LiBETI), lithium bis(trifluoromethanesulphonyl)imide, lithium bis(fluorosulphonyl)imide, lithium trifluoromethanesulfonimide (LiTFSI), an ionic liquid-based lithium salt, sodium perchlorate (NaClO₄), potassium perchlorate (KClO₄), sodium hexafluorophosphate (NaPF₆), sodium borofluoride (NaBF₄), sodium hexafluoroarsenide, sodium trifluoro-metasulfonate (NaCF₃SO₃), bis-trifluoromethyl sulfonylimide sodium (NaN(CF₃SO₂)₂), sodium trifluoromethanesulfonimide (NaTFSI), bis-trifluoromethyl sulfonylimide sodium (NaN(CF₃SO₂)₂), or a combination thereof. It may be noted that these alkali metal salts can also be used in the electrolyte that is part of the intended alkali metal secondary battery.

The solvent in this electrochemical reactor may be selected from 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofluoroether, an ionic liquid solvent, or a combination thereof. It may be further noted that these solvents can also be used in the electrolyte that is part of the intended lithium-ion battery.

### A. Production of Precursor or Supporting Thin Films of Carbon Matrix and Carbon Matrix Composites

The carbon matrix (without a graphite/carbon reinforcement phase or filler) can be produced by several processes. For instance, thin films of amorphous carbon can be deposited on a solid substrate surface using chemical vapor deposition of hydrocarbon gas introduced into a chamber at a temperature of 400-1,200° C. under a hydrogen or noble gas atmosphere. Alternatively, amorphous carbon can be produced by sputtering of carbon atoms or clusters of C atoms onto a solid substrate surface from a carbon target in a vacuum chamber. The resulting amorphous carbon films can then be peeled off from the substrate to obtain free-standing films. Alternatively, the amorphous carbon layer may be deposited directly onto a surface of an anode active layer or a surface of a separator or solid-state electrolyte layer for subsequent in situ formation of the artificial SEI layer.

In addition to or separate from amorphous carbon, polymeric carbon, or a polymer matrix, the precursor layer may contain sulfide, hydride, halide, borate, phosphate, or a combination thereof. A precursor layer of sulfide, hydride, halide, borate, or phosphate may be deposited on a solid substrate (e.g., a polymer sheet, an anode layer, a separator, or a soli-state electrolyte layer) using various known chemical (e.g., solution deposition) or physical deposition (e.g., sputtering) methods.

Carbon films may also be produced by pyrolyzation of polymer films (including thermoplastic films, thermoset films, coal tar pitch films, petroleum pitch films, etc., free-standing or coated on a solid surface), typically at an initial oxidation temperature of 250-350° C. (e.g., for polyacrylonitrile, PAN), followed by a carbonization treatment at 500-1,500° C. For other polymer films, heat treatments can go directly into the range of 500-1,500° C. without a pre-oxidation (e.g., phenolic resin). These films are herein referred to as polymeric carbon or carbonized resin films. There is no restriction on the kind of polymer or pitch material that can be pyrolyzed to produce the needed carbon matrix; but, preferably, the resin or pitch has a carbon yield of at least 20% (more preferably at least 30% and most preferably from 40% to approximately 75%).

Thin films of a polymer matrix composite (e.g., a mixture of phenolic resin+CNTs and/or graphene sheets) can be prepared in a free-standing form or coated on a solid substrate.

This can be made by a solvent mixing or melt mixing procedure that is well-known in the art. This resin matrix composite is then subjected to the heat treatments as described above (e.g. at a temperature in the range of 500-1,500° C.) to obtain carbon matrix composites.

Alternatively, one can prepare a sheet of porous non-woven, mat, paper, foam, or membrane of a carbon/graphite reinforcement material (e.g., graphene sheets, expanded graphite flakes, CNTs, carbon nano-fibers, etc.) by using any known process. This porous structure is then infiltrated with carbon using chemical vapor deposition (CVD), sputtering, or chemical vapor infiltration (CVI) to obtain a carbon matrix composite. Further alternatively, this porous structure can be impregnated with a resin or pitch material and the resulting composite be pyrolyzed to obtain a carbon matrix composite.

As a graphite/carbon reinforcement material, graphene sheets or platelets can be selected from single-layer sheets or multi-layer platelets of a graphene material selected from pristine graphene, graphene oxide having 2% to 46% by weight of oxygen, reduced graphene oxide having 0.01% to 2% by weight of oxygen, chemically functionalized graphene, nitrogen-doped graphene, boron-doped graphene, fluorinated graphene, or a combination thereof and these graphene sheets or platelets are preferably interconnected (overlapped with one another). The graphene sheets or platelets preferably have a thickness less than 10 nm, more preferably less than 2 nm. Preferably, the graphene sheets or platelets contain single-layer or few-layer graphene, wherein few-layer is defined as 10 planes of hexagonal carbon atoms or less. Preferably, the graphene planes have a controlled amount of point defects (e.g. missing C atoms, incomplete carbon hexagon structures, etc.), which are fast paths for migration of lithium or sodium ions. These point defects are typically residues of what used to be chemical functional groups (e.g. —C══O, —OH, —COOH, —NH₂, —O—, —F, —Cl, —Br, —I, etc.) originally attached to graphene planes.

The graphene sheets or platelets or exfoliated graphite flakes preferably have a length or width smaller than 1 μm, preferably smaller than 0.5 μm, more preferably smaller than 200 nm, and most preferably smaller than 100 nm. These desired dimensions are measured before these sheets/platelets/flakes are bonded by the lithium- or sodium-containing species. We have unexpectedly discovered that smaller graphene sheets normally lead to higher ion conductivity values, beneficial to rate capabilities of the battery.

As a graphite/carbon reinforcement material, CNTs can be single-walled or multi-walled. Both CNTs and CNFs (carbon nano-fibers), as well as other hard carbon, soft carbon, needle coke, and carbon black particles, can be chemically etched to produce defects that allow for easier permeation of sodium or lithium ions. Further, these carbon/graphite materials can be chemically functionalized to attach desired chemical functional groups (e.g. —C══O, —OH, —COOH, —NH₂, —O—, —F, —Cl, —Br, —I, etc.) to the ends/surfaces of these nanotubes or nano-fibers.

The carbon matrix films or carbon matrix composite films can be solid or porous. The pores eventually will be substantially filled with lithium- or sodium-containing species to form a layer of structural integrity. These lithium- or sodium-containing species are surprisingly capable of chemically bonding to the carbon matrix or the carbon/graphite reinforcement particles/fibers/nanotubes, forming a layer of lithium or sodium ion-conducting structure that is strong and tough.

In addition to or as an alternative to the carbon/graphite reinforcement phase, a filler in the form of multiple particles may be dispersed in the amorphous carbon or polymeric carbon matrix. The filler may be selected from a metal oxide, metal carbide, metal nitride, metal boride, metal dichalcogenide, or a combination thereof. In an embodiment, the filler is selected from an oxide, dichalcogenide, trichalcogenide, sulfide, selenide, or telluride of niobium, zirconium, molybdenum, hafnium, tantalum, tungsten, titanium, vanadium, chromium, cobalt, manganese, iron, or nickel in a nanowire, nano-disc, nano-ribbon, or nano platelet form.

Preferably, the filler is selected from nano discs, nano platelets, or nano sheets of an inorganic material selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof; wherein the discs, platelets, or sheets have a thickness less than 100 nm. These 2D nano materials are found to be very effective in helping to stop dendrite penetration; however, they are normally not very permeable to lithium ions or sodium ions. Hence, they should be dispersed in a carbon matrix that is permeable to lithium or sodium ions.

When a non-carbon/non-graphite filler exists in the carbon matrix, the filler amount is preferably <50% by volume, more preferably <30% by volume, and most preferably <20% by volume. When the filler and/or the carbon/graphite reinforcement phase is present in the carbon matrix, the matrix is preferably from 5% to 95% by volume (preferably from 20% to 80% by volume and more preferably from 30% to 70% by volume). The weight ratio of the carbon matrix to the lithium- or sodium-containing species can be varied from 1/100 to 100/1

### B. Methods or Processes for Producing Lithium- or Sodium-Containing Species

The preparation of artificial SEI layers may be conducted in an electrochemical reactor, which is an apparatus very similar to an electrode plating system. In this reactor, an amorphous carbon or polymeric carbon matrix (with or without a carbon/graphite reinforcement material), in the form of a mat, paper, film, etc., is used as a working electrode and lithium sheet (or sodium sheet) as a counter electrode. Contained in the reactor is an electrolyte composed of a lithium or sodium salt dissolved in a solvent (e.g., 1M LiPF₆ dissolved in a mixture of ethylene carbonate (EC) and dimethyl carbonate (DMC) at a 1:1 ratio by volume). A current is then imposed between these two electrodes (lithium or sodium sheet electrode and the carbon working electrode). The carbon matrix and the carbon/graphite reinforcement material in the working electrode are galvanostatically discharged (e.g., Li ions being sent to and captured by these carbon matrix and/or carbon/graphite reinforcement materials) and charged (Li ions released by these carbon/graphite materials) in the voltage range from 0.01V to 4.9V at the current densities of 100-1000 mA/g following a voltage-current program similar to what would be used in a lithium-ion battery. However, the system is intentionally subjected to conditions conducive to oxidative degradation of electrolyte (e.g., close to 0.01-1.0 V vs. Li/Li⁺) or reductive degradation of electrolyte (4.1-4.9 V vs. Li/Li⁺) for a sufficient length of time. The degradation products react with Li⁺ ions, Li salt, functional groups (if any) or carbon atoms on/in the carbon matrix or carbon/graphite reinforcement to form the lithium-containing species that also chemically bond to the carbon matrix or composite. Sodium-containing bonding species can be formed in a similar manner by using a sodium sheet as the counter-electrode and a sodium salt, alone or in combination with a lithium salt, is dissolved in the solvent to make a liquid electrolyte. Other electrochemical treatment conditions follow the same basic principles.

The chemical compositions of the lithium-containing species are governed by the voltage range, the number of cycles (from 0.01 V to 4.9 V, and back), solvent type, lithium salt type, chemical composition of carbon/graphite phase (e.g., % of O, H, and N attached to CNTs, CNFs, exfoliated graphite flakes, graphene sheets, etc.), and electrolyte additives (e.g., LiNO₃, if available). The morphology, structure and composition of carbon/graphite reinforcement phase, the amorphous carbon matrix, the lithium-containing species that are bonded to the carbon matrix and/or reinforcement phases can be characterized by scanning electron microscope (SEM), transmission electron microscope (TEM), Raman spectrum, X-ray diffraction (XRD), Fourier Transform Infrared Spectroscopy (FTIR), elemental analysis, and X-ray photoelectron spectroscopy (XPS).

The decomposition of non-aqueous electrolyte leads to the formation of lithium or sodium chemical compounds that bond to surface/ends of CNTs, graphene surfaces and edges, functional groups of chemically treated carbon black particles, etc. The reasons why the non-aqueous electrolyte is decomposed during discharge-charge cycling in an electrochemical reactor may be explained as follows.

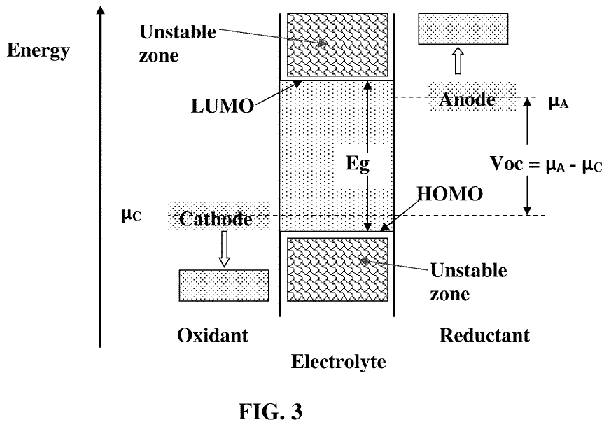

As illustrated in FIG. 3, in an electrochemical reactor system where there are a cathode and an anode in contact with an electrolyte, the thermodynamic stability of the electrolyte is dictated by the relative electron energies of the two electrodes relative to the energy level of the non-aqueous electrolyte. The anode is potentially a reductant, and the cathode an oxidant. The two electrodes are typically electronic conductors and, in this diagram, their electrochemical potentials are designated as μA and μc (or Fermi energies ε_{F}), respectively. The energy separation, E_{g}, between the lowest unoccupied molecular orbital (LUMO) and the highest occupied molecular orbital (HOMO) of the electrolyte is the stable electrochemical window of the electrolyte. In other words, in order for the electrolyte to remain thermodynamically stable (i.e. not to decompose), the electrochemical potential of the anode (μ_{A}) should be maintained below the LOMO and μ_{C} of the cathode should be above the HOMO.

From the schematic diagram of FIG. 3, we can see that an anode with μ_{A} above the LUMO and a cathode with μ_{C} below the HOMO will reduce and oxidize the electrolyte, respectively, unless a passivating film is formed that creates a barrier to electron transfer between the anode and electrolyte or between the cathode and the electrolyte. In the presently invented method, an external current/voltage is intentionally applied over the anode and the cathode to bias their respective electrochemical potential levels so that the electrolyte can go outside of the stable electrochemical potential window, undergoing oxidative and/or reductive degradation. The degradation products are reactive species that react among themselves and with the functional groups or active atoms of carbon matrix and/or carbon/graphite reinforcement phase, forming a mass of lithium- or sodium-containing species that bond the carbon matrix and the reinforcement phase materials together.

For the list of lithium/sodium salts and solvents investigated, the electrolytes have an oxidation potential (HOMO) at about 4.7 V and a reduction potential (LUMO) near 1.0 V. (All voltages in this specification are with respect to Li⁺/Li or Na⁺/Na). We have observed that the chemical interaction of Li⁺ or Na⁺ ions with graphene planes or edges occur at about 0.01-0.8 V, so electrolytes are prone to reductive degradation in the voltage range of 0.01-0.8 V. By imposing a voltage close to 4.7 volts, the electrolytes are also subject to oxidative degradation. The degradation products spontaneously react with chemical species associated with the carbon matrix and/or reinforcement materials (e.g., graphene planes or edges), forming a material phase that bonds together with carbon matrix and/or reinforcement materials during the charge-discharge cycling (electrolyte reduction-oxidation cycling). In general, these lithium- or sodium-containing species are not electrically conducting and, hence, these reactions can self-terminate to form essentially a passivating phase.

The electrolytes that can be used in this electrochemical decomposition reactor may be selected from any lithium or sodium metal salt that is dissolvable in a solvent to produce an electrolyte. The desirable salts and solvents have been discussed earlier.

Carbon/graphite-based reinforcement materials that can be used to strengthen the carbon matrix in the artificial SEI layer include carbon nanotubes (CNTs), carbon nano-fibers (CNFs), graphene sheets/platelets, expanded graphite flakes, fine particles of carbon black (CB) or acetylene black (AB), needle coke, etc. These species should preferably have a diameter or thickness less than 1 μm, preferably less than 500 nm, more preferably less than 200 nm, and most preferably less than 100 nm. Traditional carbon fibers or graphite fibers, having a diameter of typically 6-12 μm, are not preferred choices if one desires to make a dendrite-stopping layer thinner than 10 μm for the purpose of reducing battery volume and weight.

Most of these materials are commercially available. Some of the preferred reinforcement materials and their treatments are herein described. In a preferred embodiment, the graphene sheets in an artificial SEI layer is selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof. Alternatively, the backbone of an SEI layer may be selected from flakes of an exfoliated graphite material. The production of graphene sheets, exfoliated graphite or expanded graphite flakes, and carbon nanotubes are well-known in the art.

For the purpose of defining the claims of the instant application, NGPs or graphene materials include discrete sheets/platelets of single-layer and multi-layer (typically less than 10 layers) pristine graphene, graphene oxide, reduced graphene oxide (RGO), graphene fluoride, graphene chloride, graphene bromide, graphene iodide, hydrogenated graphene, nitrogenated graphene, chemically functionalized graphene, doped graphene (e.g. doped by B or N). Pristine graphene has essentially 0% oxygen. RGO typically has an oxygen content of 0.001%-5% by weight. Graphene oxide (including RGO) can have 0.001%-50% by weight of oxygen. Other than pristine graphene, all the graphene materials have 0.001%-50% by weight of non-carbon elements (e.g., O, H, N, B, F, Cl, Br, I, etc.). These materials are herein referred to as non-pristine graphene materials.

Pristine graphene, in smaller discrete graphene sheets (typically 0.3 μm to 10 μm), may be produced by direct ultrasonication (also known as liquid phase exfoliation or production) or supercritical fluid exfoliation of graphite particles. These processes are well-known in the art.

The graphene oxide (GO) may be obtained by immersing powders or filaments of a starting graphitic material (e.g., natural graphite powder) in an oxidizing liquid medium (e.g. a mixture of sulfuric acid, nitric acid, and potassium permanganate) in a reaction vessel at a desired temperature for a period of time (typically from 0.5 to 96 hours, depending upon the nature of the starting material and the type of oxidizing agent used). As previously described above, the resulting graphite oxide particles may then be subjected to thermal exfoliation or ultrasonic wave-induced exfoliation to produce isolated GO sheets. These GO sheets can then be converted into various graphene materials by substituting —OH groups with other chemical groups (e.g. —Br, NH₂, etc.).

Several well-known techniques can be employed to fabricate a conductive layer of porous carbon/graphite reinforcement structure (a web, mat, paper, non-woven, foam, or porous film, etc.), which is a monolithic body having desired interconnected pores that are accessible to carbon matrix to be infiltrated later. Some residual pores after carbon matrix infiltration can remain accessible to the liquid electrolyte in an electrochemical decomposition reactor. These electrolytes are to be intentionally decomposed under the oxidation-reduction cycling conditions discussed earlier to form the desired lithium- or sodium-containing species that are chemically bonded to the carbon matrix and/or the carbon/graphite reinforcement materials (e.g., CNTs, graphene sheets, etc.).

Alternatively, rolls of porous carbon/graphite paper/mat may be readily produced in a cost-effective manner using other well-known paper-making, foam-making, or mat-making techniques, etc.

The porous structure (e.g., paper, mat, foam, etc.) is then subjected to carbon infiltration via direct CVI or liquid infiltration by a resin or pitch material, followed by pyrolyzation. The resulting carbon matrix composite, solid or porous, is then subjected to the electrochemical decomposition treatment to form the lithium- or sodium-containing species in the interstitial spaces, gaps, or voids (if any) but bonded to the pore walls, or simply bonded to surfaces of the carbon matrix composite to form a dendrite-intercepting layer. In such a dendrite penetration resistant layer, the graphene sheets or platelets or exfoliated graphite flakes are bonded by the carbon matrix and/or the lithium- or sodium-containing species.

For industrial-scale production of the presently disclosed artificial SEI layer, the electrochemical decomposition treatment may be carried out also in a roll-to-roll manner. In an embodiment, the continuous-length paper (or mat, foam, membrane, etc.) of carbon matrix, carbon/graphite reinforcement, or their carbon matrix composite may be unwound from a feeder roller, and moved to enter an electrochemical treatment zone (essentially an electrochemical decomposition reactor) containing an electrolyte therein. A lithium or sodium electrode is immersed in this electrolyte and the paper is also electrically wired as the working electrode. The paper is moved at a controlled speed to give enough time for electrochemical decomposition of the electrolyte to occur. The paper, impregnated with and/or bonded by the decomposition products, is then wound up on a take-up roller. This roll-to-roll or reel-to-reel process can be easily scaled up and automated for mass production of the presently invented dendrite penetration resistant layer products.

In an alternative embodiment, the continuous-length paper may be unwound from a feeder roller, deposited with some lithium or sodium metal (e.g., using physical vapor deposition or sputtering of Li) while the paper is in a dry state (before contacting electrolyte). The Li- or Na-deposited paper is then moved to enter an electrochemical treatment zone containing an electrolyte therein. As soon as the Li-paper layer or Na-paper layer enters the electrolyte, essentially short-circuiting occurs between the carbonaceous/graphitic paper and Li (or Na). In other words, the paper “electrode” is essentially placed in an electrochemical potential that is 0 V with respect to Li⁺/Li or Na⁺/Na, subjecting the electrolyte to a reductive decomposition and enabling decomposition products to react with graphene. Optionally, a lithium or sodium electrode is implemented and immersed in this electrolyte and the graphene paper is also electrically wired as the working electrode. Such an arrangement aids in continuing the electrochemical decomposition of electrolytes and formation of the bonding Li- or Na-containing species. The graphene paper is moved at a controlled speed to give enough time for electrochemical decomposition of the electrolyte to occur. The graphene paper, impregnated with and bonded by the decomposition products, is then wound up on a take-up roller. Again, this roll-to-roll process is highly scalable and can be fully automated for cost-effective production of the desired dendrite-stopping layer product.

Thus, an alternative embodiment of the method or process for producing the artificial SEI layer comprises (a) preparing a working electrode containing a layer of the carbon matrix or carbon matrix composite; (b) preparing a counter electrode containing lithium or sodium metal or alloy; and (c) bringing the working electrode and the counter electrode in physical contact with each other and in contact with an electrolyte containing a solvent and a lithium salt or sodium salt dissolved in the solvent; wherein the working electrode and the counter electrode are brought to be at the same electrochemical potential level, inducing a chemical reaction between the lithium/sodium metal or alloy and the carbon matrix or carbon matrix composite, and inducing electrochemical decomposition of the electrolyte for forming the lithium- or sodium-containing species that are chemically bonded to the carbon matrix and/or the reinforcement phase to produce the artificial SEI layer either outside of or inside an intended lithium-ion battery. In an embodiment, this process is conducted in a roll-to-roll manner outside of the intended rechargeable alkali metal battery. Alternatively, this process is conducted inside the intended lithium-ion battery; the battery itself is regarded as an electrochemical decomposition reactor.

The present disclosure also provides a method of producing a lithium-ion battery featuring an artificial SEI layer. As illustrated in FIG. 4(B), this method comprises:

(a) preparing a lithium-ion battery cell comprising (i) an anode layer, (ii) a precursor or supporting layer comprising sulfide, hydride, halide, borate, phosphate, amorphous carbon, polymeric carbon, or a polymer matrix, (iii) a solid-state electrolyte, different in composition than the precursor or supporting layer, or a porous separator layer and a second electrolyte, and (iv) a cathode layer, wherein the precursor or supporting layer of sulfide, hydride, halide, borate, phosphate, amorphous carbon, polymeric carbon, or polymer matrix is laminated between the anode layer and the porous separator or solid-state electrolyte layer, and the porous separator or solid-state electrolyte layer is disposed between the precursor or supporting layer and the cathode layer; and
(b) subjecting the battery cell to a voltage/current treatment that induces electrochemical reductive and/or oxidative decomposition of the solid-state electrolyte, the second electrolyte, the sulfide, hydride, halide, borate, or phosphate to form the lithium- and/or sodium-containing species that are chemically bonded to the amorphous carbon, polymeric carbon, or polymer matrix or bonded to the anode, the solid-state electrolyte, or the separator layer to form the artificial SEI layer in the battery cell. The voltage/current treatment may include subjecting the solid-state electrolyte, the second electrolyte, the sulfide, hydride, halide, borate, phosphate, or a combination thereof to an electrochemical potential beyond a thermodynamically stable region for these materials.

In certain embodiments, step (a) of preparing a lithium-ion battery cell comprises depositing sulfide, hydride, halide, borate, phosphate, amorphous carbon, polymeric carbon, or a polymer matrix onto the anode layer or the porous separator or the solid-state electrolyte layer to form a layer up to a thickness from 10 nm to 20 μm.

In some embodiments, step (b) is conducted by subjecting the battery cell to a charge-discharge treatment to induce electrochemical oxidative and/or reductive decomposition of the electrolyte (e.g., including at least a procedure of charging/discharging the battery cell to put the anode layer at an electrochemical potential below 0.8 V relative to Li/Li⁺ to induce reductive decomposition reactions, or to a voltage close to 4.7 V, say from 4.0 V to 5.0 V, to induce oxidative decomposition of the electrolyte). The decomposition products chemically react with graphene sheets or exfoliated graphite flakes to form a dendrite-stopping layer in situ inside a battery cell.

The artificial SEI layer of the instant disclosure typically exhibits a lithium ion or sodium ion conductivity from 2.5×10⁻⁵ S/cm to 5.5×10⁻³ S/cm, and more typically from 1.0×10⁻⁴ S/cm to 2.5×10⁻³ S/cm. There is no restriction on the thickness of the dendrite-intercepting layer, but for practical purposes, the dendrite penetration-resistant layer preferably has a thickness from 2 nm to 20 μm, more preferably from 10 nm to 10 μm, and most preferably from 100 nm to 1 μm.

The electrolytic salts to be incorporated into an electrolyte of a lithium-ion battery may be selected from a lithium salt such as lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium [LiN(CF₃SO₂)₂], lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoroethysulfonylimide (LiBETI), an ionic liquid salt, and their sodium counterparts. Among them, LiPF₆, LiBF₄ and LiN(CF₃SO₂)₂ are preferred. The content of aforementioned electrolytic salts in the non-aqueous solvent is preferably 0.5 to 3.0 M (mol/L).

The disclosure also provides a lithium-ion cell comprising an anode (prelithiated or non-prelithiated), a cathode comprising a cathode active material, an ion-permeable separator that electrically separates the anode and the cathode, and an artificial SEI layer disposed between the anode and the separator. The cathode may be produced by any known process; e.g., the commonly used slurry coating and drying procedure. There is no restriction on the types of cathode materials or the processes that can be used.

The cathode active material may be selected from an inorganic material, an organic material, a polymeric material, or a combination thereof. In general, in order to make use of a cathode active material having no lithium contained in the cathode material structure (e.g., CoF₃, MnF₃, FeF₃, TiS₂, TaS₂, MoS₂, NbSe₃, MnO₂, CoO₂, etc.), the anode is preferably prelithiated to at least 40%, and more preferably from 50% to 100%. For a lithiated cathode active material (e.g., lithium transition metal oxides such as NCM and NCA), the anode may be prelithiated to less than 40%.

The inorganic material may be selected from a metal oxide, metal phosphate, metal silicide, metal selenide, transition metal sulfide, sulfur, lithium polysulfide, selenium, lithium selenide, or a combination thereof. In some embodiments, the inorganic material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

The inorganic material may be selected from a lithium transition metal silicate, denoted as Li₂MSiO₄ or Li₂MaₓMb_{y}SiO₄, wherein M and Ma are selected from Fe, Mn, Co, Ni, or V, Mb is selected from Fe, Mn, Co, Ni, V, Ti, Al, B, Sn, or Bi; and x+y≤1. Examples of the lithium transition metal oxide- or lithium mixed transition metal oxide-based positive active materials include: Li (M′_{X}M″_{Y})O₂, where M′ and M″ are different metals (e.g., Li(Ni_{X}Mn_{Y})O₂, Li(Ni_{1/2}Mn_{1/2})O₂, Li(Cr_{X}Mn_{1-X})O₂, Li(Al_{X}Mn_{1-X})O₂, Li(Co_{X}M_{1-X})O₂, where M is a metal, (e.g., Li(Co_{X}Ni_{1-X})O₂ and Li(Co_{X}Fe_{1-X})O₂), Li_{1-W}(Mn_{X}Ni_{Y}Co_{Z})O₂, (e.g. Li(Co_{X}Mn_{Y}Ni_{(1-X-Y)})O₂, Li(Mn_{1/3}Ni_{1/3}Co_{1/3})O₂, Li(Mn_{1/3}Ni_{1/3}Co_{1/3-X}Mg_{X})O₂, Li(Mn_{0.4}Ni_{0.4}Co_{0.2})O₂, Li(Mn_{0.1}Ni_{0.1}Co_{0.8})O₂, Li_{1-W}(Mn_{X}Ni_{X}Co_{1-2X})O₂, Li_{1-W}Mn_{X}Ni_{Y}CoAl_{W})O₂, Li_{1-W}(Ni_{X}Co_{Y}Al_{Z})O₂, where W=0-1, (e.g., Li(Ni_{0.8}Co_{0.15}Al_{0.05})O₂, Li_{1-W}(Ni_{X}Co_{Y}M_{Z})O₂, where M is a metal, Li_{1-W}(Ni_{X}Mn_{Y}M_{Z})O₂, where M is a metal, Li(N_{X}Mn_{Y}Cr_{2-X})O₄, LiM′M″₂O₄, where M′ and M″ are different metals (e.g., LiMn_{2-Y-Z}Ni_{Y}O₄, LiMn_{2-Y-Z}Ni_{Y}Li_{Z}O₄, LiMn_{1.5}Ni_{0.5}O₄, LiNiCuO₄, LiMn_{1-X}Al_{X}O₄, LiNi_{0.5}Ti_{0.5}O₄, Li_{1.05}Al_{0.1}Mn_{1.85}O_{4-z}F_{z}, Li₂MnO₃)Li_{X}V_{Y}O_{Z}, e.g. LiV₃O₈, LiV₂O₅, and LiV₆O₁₃.

The metal oxide contains a vanadium oxide selected from the group consisting of VO₂, LiₓVO₂, V₂O₅, LiₓV₂O₅, V₃O₈, LiₓV₃O₈, V₄O₉, LiₓV₄O₉, V₆O₁₃, LiₓV₆O₁₃, their doped versions, their derivatives, and combinations thereof, wherein 0.1<x<5.

In certain desired embodiments, the inorganic material is selected from a lithium-free cathode material. Such an initially lithium-free cathode may contain a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof. In these cases, it is particularly desirable to have the anode active material prelithiated to a high level, preferably no less than 50%.

The inorganic material may be selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The inorganic material may be selected from a transition metal dichalcogenide, a transition metal trichalcogenide, or a combination thereof. The inorganic material may be selected from TiS₂, TaS₂, MoS₂, NbSe₃, MnO₂, CoO₂, an iron oxide, a vanadium oxide, or a combination thereof.

The metal oxide or metal phosphate may be selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The organic material or polymeric material may be selected from Poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, Quino(triazene), redox-active organic material, Tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS2)3]n), lithiated 1,4,5,8-naphthalenetetraol formaldehyde polymer, Hexaazatrinaphtylene (HATN), Hexaazatriphenylene hexacarbonitrile (HAT(CN)6), 5-B enzylidene hydantoin, Isatine lithium salt, Pyromellitic diimide lithium salt, tetrahydroxy-p-benzoquinone derivatives (THQLi4), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAM), calixquinone, Li₄C₆O₆, Li₂C₆O₆, Li₆C₆, O₆, or a combination thereof.

The thioether polymer is selected from Poly[methanetetryl-tetra(thiomethylene)] (PMTTM), Poly(2,4-dithiopentanylene) (PDTP), a polymer containing Poly(ethene-1,1,2,2-tetrathiol) (PETT) as a main-chain thioether polymers, a side-chain thioether polymer having a main-chain consisting of conjugating aromatic moieties, and having a thioether side chain as a pendant, Poly(2-phenyl-1,3-dithiolane) (PPDT), Poly(1,4-di(1,3-dithiolan-2-yl)benzene) (PDDTB), poly(tetrahydrobenzodithiophene) (PTHBDT), poly[1,2,4,5-tetrakis(propylthio)benzene] (PTKPTB, or poly[3,4(ethylenedithio)thiophene] (PEDTT).

The following examples serve to illustrate the preferred embodiments of the present disclosure and should not be construed as limiting the scope of the disclosure:

### EXAMPLE 1: PREPARATION OF INORGANIC SOLID ELECTROLYTE (ISE), LITHIUM NITRIDE PHOSPHATE COMPOUND (UPON)

Particles of Li₃PO₄ (average particle size 4 μm) and urea were prepared as raw materials; 5 g each of Li₃PO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (UPON). The compound was ground in a mortar into a powder form. These ISE particles can be combined with an in situ cured polymer to form a hybrid solid-state or quasi-solid electrolyte in an anode, a cathode, and/or a separator. Alternatively, a sintered monolithic body of UPON can be used as a solid-state electrolyte separator layer.

### EXAMPLE 2: PREPARATION OF SOLID ELECTROLYTE, LITHIUM SUPERIONIC CONDUCTORS WITH THE Li₁₀GeP₂S₁₂ (LGPS)-TYPE STRUCTURE

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into discs or sheets, placed into a graphite crucible, and then sealed at 10 Pa in a carbon-coated quartz tube. After being heated at a reaction temperature of 1,000° C. for 5 h, the tube was quenched into ice water. The resulting inorganic solid electrolyte discs or sheets can be used directly as a solid-state electrolyte separator. In some cases, they were then subjected to grinding in a mortar to form a powder sample to be later added as inorganic solid electrolyte particles dispersed in an intended polymer electrolyte matrix.

### EXAMPLE 3: PREPARATION OF GARNET-TYPE INORGANIC SOLID ELECTROLYTE POWDER

The synthesis of the c-Li_{6.25}Al_{0.25}La₃Zr₂O₁₂ was based on a modified sol-gel synthesis-combustion method, resulting in sub-micron-sized particles after calcination at a temperature of 650° C. (J. van den Broek, S. Afyon and J. L. M. Rupp, Adv. Energy Mater., 2016, 6, 1600736).

For the synthesis of cubic garnet particles of the composition c-Li_{6.25}Al_{0.25}La₃Zr₂O₁₂, stoichiometric amounts of LiNO₃, Al(NO₃)₃—9H₂O, La(NO₃)₃—6(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li_{6.25}Al_{0.25}La₃Zr₂O₁₂, which was ground to a fine powder in a mortar for further processing.

The c-Li_{6.25}Al_{0.25}La₃Zr₂O₁₂ solid electrolyte pellets with relative densities of ˜87±3% made from this powder (sintered in a horizontal tube furnace at 1070° C. for 10 h under O₂ atmosphere) exhibited an ionic conductivity of ˜0.5×10⁻³ S cm⁻¹ (RT). The garnet-type solid electrolyte with a composition of c-Li_{6.25}Al_{0.25}La₃Zr₂O₁₂ (LLZO) was made into a separator sheet or in a powder form.

### EXAMPLE 4: PREPARATION OF SODIUM SUPERIONIC CONDUCTOR (NAS ICON) TYPE INORGANIC SOLID ELECTROLYTE POWDER

The Na_{3.1}Zr_{1.95}M_{0.05}Si₂PO₁₂ (M=Mg, Ca, Sr, Ba) materials were synthesized by doping with alkaline earth ions at octahedral 6-coordination Zr sites. The procedure employed consists of two sequential steps. Firstly, solid solutions of alkaline earth metal oxides (MO) and ZrO₂ were synthesized by high energy ball milling at 875 rpm for 2 h. Then NASICON Na_{3.1}Zr_{1.95}M_{0.05}Si₂PO₁₂ structures were synthesized through solid-state reaction of Na₂CO₃, Zr_{1.95}M_{0.05}O_{3.95}, SiO₂, and NH₄H₂PO₄ at 1260° C.

### EXAMPLE 5: ANODE CONTAINING Ge PARTICLES

Several anode electrodes were prepared by mixing 85 wt. % active material (Ge particles having a size range of 2.3-5.6 μm), 0-5 wt. % graphite particles (0, 1%, 3%, and 5%), and 0-3 wt. % (0%, 1%, 2%, and 3%) polyvinylidene fluoride (PVDF) binder dissolved in N-methyl pyrrolidinoe (NMP) to form a slurry containing 5 wt. % total solid content. After coating the slurries on Cu foil, the electrodes were dried at 120° C. in vacuum for 2 h to remove the solvent. These pre-fabricated anode electrodes were then deposited with a layer of precursor (C, sulfide, hydride, and fluoride) using CVD (carbon) and sputtering (sulfide, hydride, and fluoride). In some samples, a layer of LLZO-reinforced poly(vinylidene fluoride)-hexafluoropropylene (PVDF-HFP co-polymer) was used as a supporting layer.

Then, the electrodes were cut into a disk (ϕ=12 mm). Electrochemical measurements were carried out using CR2032 (3V) coin-type cells with a LiCoO₂ cathode, Celgard 2400 membrane as a separator, Ge anode supported precursor layer, and 1 M LiPF₆ electrolyte solution dissolved in a mixture of ethylene carbonate (EC) and diethyl carbonate (DEC) (EC-DEC, 1:1 v/v). In certain samples, polymer electrolytes were used in the cathode and the anode is substantially electrolyte-free. The cell assembling procedure was performed in an argon-filled glove-box. The CV measurements were carried out using an electrochemical workstation at a scanning rate of 1 mV/s.

### EXAMPLE 6: ANODES COMPRISING SILICON (Si) PARTICLES

Micron-, sub-micron, and nanometer sized Si particles were obtained from commercial sources. Various different types of Si particles were combined with 0%-3% (0%, 0.1%, 0.5%, 1%, and 3%) CNTs (a conductive additive), and 0%-5% of a CMC binder resin to form a layer of pre-fabricated anode bonded to a Cu foil using the slurry coating procedure. Some of these anodes are binder-free and/or conductive additive-free. A precursor layer of sulfide, borate, and phosphorate, separately, was then deposited onto the surface (opposing the Cu foil) of the pre-fabricated Si-based anode.

A thin layer of lithium metal film was then attached to a surface of the precursor layer supported by a pre-fabricated anode and the resulting laminate (consisting of the Cu foil, a Si-based active material layer, a precursor layer, and a lithium metal film) was then immersed in a lithium salt solution containing LiPF₆ salt dissolved in EC-PC (50/50) as an electrolyte solution. This created an electrically shorting condition, putting the precursor layer at an electrochemical potential very close to that of Li/Li⁺ which induced reductive decomposition of the liquid electrolyte and reactions with the precursor layer to convert the precursor layer into an artificial SEI layer. This electrically shorting condition also allowed lithium ions to rapidly diffuse into the bulk of Si particles. With this procedure, one could achieve a degree of prelithiation of 1-100% in the Si particles.

These Si-rich anodes, upon prelithiation and proper protection by an artificial SEI layer, were used to pair up with initially lithium-free cathode materials (e.g., FeF₃, CuF₂, and MoS₂) for forming lithium-ion cells. With a prelithiation level less than 30%, the partnering cathode active materials include the well-known NCM-811, NCA, and NMA (lithium manganese aluminum oxide). The separators used in the lithium-ion cells were a sintered sheet of LLZO, sulfide (prepared in Example 2), and PVDF-HFP co-polymer layer.

### EXAMPLE 7: Si NANOWIRE-BASED ANODE MATERIALS

Si nanowires, having a diameter range from 19 to 28 nm, were supplied from Angstron Energy Co. (Dayton, Ohio). Similar procedures as described in Example 6 were followed to produce lithium-ion cells containing Si nanowires as the anode active material.

### EXAMPLE 8: PREPARATION OF POLYMERIC CARBON (AS A PRECURSOR OR SUPPORTING LAYER) BY PYROLYZATION OF A POLYMER FILM

Several carbon films were produced by pyrolyzation of polyacrylonitrile (PAN) films. Solvent cast PAN films having an initial thickness from approximately 3 μm to 10 μm were made on a glass plate surface. These polymer films were heat treated at an initial oxidation temperature of 250° C. for 1 hour under a small biaxial tension stress. This was followed by a carbonization treatment at 500° C. and then gradually raised to 1,000° C. over a period of 4 hours in an argon atmosphere to produce polymeric carbon films. Several polymeric carbon films were used as an electrode in an electrochemical decomposition reactor to form the artificial SEI layers.

### EXAMPLE 9: PREPARATION OF AMORPHOUS CARBON ON AN ANODE LAYER OF Si, Sn, AND Si—Sn MIXTURES

Powder of Si, Sn, and Si—Sn mixtures were separately made into anode layers each supported by a Cu foil. Some of the anodes contain no resin binder and/or a conductive additive. The open surface (opposing the Cu foil surface) of each anode is deposited with a layer of amorphous carbon, 0.5-3 μm thick. The resulting three-layer structure (Cu/anode material/C) was then covered with a sulfide-based solid-state separator (prepared in Example 2), and a layer of cathode active material (coated on an Al foil current collector) to form a battery unit cell. In some cases, the solid-state electrolyte separate is based on a Li₆PS₅Cl argyrodite. The cathode layer was pre-impregnated with a liquid electrolyte. Several cathode active materials were used: LiMn₂O₄, NCM-622, and NCA. The battery system was intentionally subjected to conditions conducive to reductive degradation of electrolyte (e.g., close to 0.01-1.0 V vs. Li/Li⁺) and oxidative degradation of electrolyte (e.g., 4.1-4.9 V vs. Li/Li⁺) for the first 3 charge-discharge cycles to produce the desired lithium-containing species. After these, the battery is allowed to operate under normal operating conditions (e.g., cycling between 1.5 and 3.7 volts for the Li—LiMn₂O₄ battery).

### EXAMPLE 10: ELECTROCHEMICAL PREPARATION OF ARTIFICIAL SEI LAYERS CONTAINING CARBON MATRIX OR CARBON MATRIX COMPOSITE BONDED BY LITHIUM CHEMICAL SPECIES

The preparation of artificial SEI layers was carried out in an electrochemical reactor, an apparatus very similar to an electrode plating system. In this reactor, a layer of carbon matrix or carbon matrix composite structure (in the form of a mat, paper, film, etc. as prepared in previous 12 examples) was used as a working electrode and lithium sheet as both the counter and reference electrodes. Inside the reactor is an electrolyte composed of 1M LiPF₆ dissolved in a mixture of ethylene carbonate (EC) and dimethyl carbonate (DMC) (1:1 by volume), as an example. The carbon matrix or composite layer in the working electrode was galvanostatically discharged (Li ions being sent to this working electrode) and charged (Li ions partially released by this working electrode) in the voltage range from 0.01V to 4.9V at the current densities of 100-1000 mA/g following a voltage-current program similar to what would be used in a lithium-ion battery. However, the system was intentionally subjected to conditions conducive to reductive degradation of electrolyte (close to 0.01-1.0 V vs. Li/Li⁺) or oxidative degradation of electrolyte (e.g., 4.1-4.9 V vs. Li/Li⁺) for a sufficient length of time. The degradation products react with Li⁺ ions, Li salt, functional groups (if any) or carbon atoms on the carbon matrix or composite to form the lithium-containing species that are also chemically bonded to the carbon matrix and/or carbon/graphitic reinforcement materials (e.g., CNTs, CNFs, graphene, exfoliated graphite flakes, etc.) dispersed therein.

The chemical compositions of the lithium-containing species are governed by the voltage range, the number of cycles (from 0.01 V to 4.9 V, and back), solvent type, lithium salt type, chemical composition of carbon matrix and the carbon/graphite reinforcement phase (e.g., % of O, H, and N), and electrolyte additives (e.g., LiNO₃), if available.

The morphology, structure and composition of the carbon matrix, composites, the lithium-containing species that are bonded to carbon matrix or composites were characterized by scanning electron microscope (SEM), transmission electron microscope (TEM), Raman spectrum, X-ray diffraction (XRD), and X-ray photoelectron spectroscopy (XPS). An extensive investigation that covers a broad range of lithium salts, solvents, and additives lead to the following discoveries:

A wide range of lithium-containing species were formed in a controlled manner and these species were well-bonded to the carbon matrix and/or carbon/graphite reinforcement phase. The resulting lithium chemical species-bonded integral layers are of structural integrity, robust enough to stop further reactions between electrolyte and an anode active material. In these layers, species (CH₂OCO₂Li)₂ is a two-electron reduction product of ethylene carbonate (EC) in an EC-based electrolytes. ROCO₂Li species are present between carbon or graphitic material in electrolytes containing propylene carbonate (PC), especially when the concentration of PC in the electrolyte is high. Li₂CO₃ is present on carbon matrix or carbon/graphite reinforcement surfaces in EC or PC based electrolytes when a higher voltage is imposed for an extended period of time. This species also appear as a reaction product of semi-carbonates with HF or water or CO₂. ROLi is produced on carbon matrix in ether electrolytes such as tetrahydrofuran (THF), dimethyl carbonate (DMC), or ethyl methyl carbonate (EMC) as an electrochemical reduction product at an electrochemical potential lower than 0.5 V vs. Li/Li⁺.

LiF is readily formed in electrolytes containing fluorinated salts such as LiAsF₆, LiPF₆, and LiBF₄, as a salt reduction product. Li₂O is a degradation product of Li₂CO₃. LiOH is formed when a small but controlled amount of water is added to the reactor. Species such as Li₂C₂O₄, Li carboxylate, Li methoxide, are formed in electrolytes containing 1-2 M of LiPF₆ in EC:EMC (e.g. at a 3:7 ratio). HCOLi is formed when methyl formate is used as a co-solvent or additive in the electrolyte.

### EXAMPLE 11: ELECTROCHEMICAL PREPARATION OF ARTIFICIAL SEI LAYERS CONTAINING CARBON MATRIX OR CARBON MATRIX COMPOSITE BONDED BY/TO SODIUM-CONTAINING CHEMICAL SPECIES

The same electrochemical reactor was used for preparation of artificial SEI layers featuring sodium-containing chemical species. Again, a carbon matrix or carbon matrix composite structure (in the form of a mat, paper, film, etc.) was used as a working electrode and sodium sheet or rod as both the counter and reference electrodes. Inside the reactor is an electrolyte composed of a sodium salt dissolved in a solvent or mixture of solvents.

Sodium salts used in this example include sodium perchlorate (NaClO₄), sodium hexafluorophosphate (NaPF₆), sodium borofluoride (NaBF₄), and sodium trifluoromethane-sulfonimide (NaTFSI). Solvents used include 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (γ-BL), acetonitrile (AN), ethyl acetate (EA), propyl formate (PF), methyl formate (MF), methyl acetate (MA), fluoroethylene carbonate (FEC), vinylene carbonate (VC), and allyl ethyl carbonate (AEC).

The carbon matrix or carbon matrix composite materials in the working electrode were galvanostatically discharged (Na ions being sent to the carbon matrix or carbon matrix composite) and charged (Na ions released by carbon matrix or carbon matrix composite) in the voltage range from 0.01V to 4.7V at the current densities of 100-1000 mA/g following a voltage-current program similar to what would be used in a lithium-ion battery. However, the system was intentionally subjected to conditions conducive to reductive degradation of electrolyte (close to 0.01 V-0.8 V vs. Na/Na⁺) or oxidative degradation of electrolyte (3.8-4.7 V vs. Na/Na⁺) for a sufficient length of time. The degradation products react with Na⁺ ions, Na salt, functional groups (containing O, H, N, etc.) or carbon atoms on carbon matrix or carbon matrix composite to form the sodium-containing species that are also chemically bonded to the carbon matrix and/or carbon/graphite reinforcement phase.

The chemical compositions of the sodium-containing species are dictated by the voltage range, the number of cycles (from 0.01 V to 4.7 V, and back), solvent type, sodium salt type, chemical composition of graphene sheets (e.g., % of O, H, and N), and electrolyte additives (e.g. NaNO₃), if available. An extensive investigation that covers a broad range of lithium salts, solvents, and additives lead to the following discoveries:

A wide range of sodium-containing species were formed in a controlled manner and these species are typically well-bonded to the carbon matrix or carbon matrix composite. The resulting integral layers are of structural integrity and surprisingly conductive to lithium ions.

In these layers, species (CH₂OCO₂Na)₂ is believed to be a two-electron reduction product of ethylene carbonate (EC) in an EC-based electrolytes. ROCO₂Na species are present on carbon matrix or carbon matrix composite in electrolytes containing propylene carbonate (PC), especially when the concentration of PC in the electrolyte is high. Na₂CO₃ is present on carbon matrix or carbon matrix composite in EC or PC based electrolytes when a higher voltage is imposed for an extended period of time. This species also appear as a reaction product of semi-carbonates with HF or water or CO₂.

RONa is produced on carbon matrix or carbon matrix composite in ether electrolytes such as tetrahydrofuran (THF), dimethyl carbonate (DMC), or ethyl methyl carbonate (EMC) as an electrochemical reduction product at an electrochemical potential lower than 0.5 V vs. Na/Na⁺. NaF is readily formed in electrolytes containing fluorinated salts such as NaAsF₆, NaPF₆, and NaBF₄, as a salt reduction product. Na₂O is a degradation product of Na₂CO₃. NaOH is formed when a small but controlled amount of water is added to the reactor. Species such as Na₂C₂O₄, Na carboxylate, Na methoxide, are formed in electrolytes containing 1-2 M of NaPF₆ in EC:EMC (e.g. at a 3:7 ratio). HCONa is formed when methyl formate is used as a co-solvent or additive in the electrolyte.

In summary, the present disclosure provides an innovative, versatile, and surprisingly effective platform materials technology that enables the design and manufacture of superior and safe lithium-ion batteries. The high volume change-induced capacity decay problem can be effectively overcome, making it possible for these high-energy batteries to be widely implemented for electric vehicle, renewable energy storage, and electronic device applications.

1. A lithium-ion battery comprising an anode, a cathode, a lithium-ion permeable and electrically insulating separator that electrically separates the anode from the cathode, and an artificial solid-electrolyte interface (SEI) layer disposed between the anode and the separator wherein (a) the artificial SEI layer has a lithium-ion conductivity greater than 10⁻⁶ S/cm and (b) the anode comprises (i) multiple particles of an anode active material selected from the group consisting of silicon (Si), germanium (Ge), phosphorus (P), tin (Sn), lead (Pb), antimony (Sb), bismuth (Bi), zinc (Zn), aluminum (Al), titanium (Ti), nickel (Ni), cobalt (Co), cadmium (Cd), alloys thereof, alloys thereof with lithium (Li), and combinations thereof; (ii) 0-10% by weight of a conductive additive; and (iii) 0-10% by weight of a binder resin.

2. The lithium-ion battery of claim 1, wherein said artificial SEI layer has a lithium-ion conductivity from 10⁻⁵ S/cm to 10⁻² S/cm.

3. The lithium-ion battery of claim 1, wherein said artificial SEI layer comprises a lithium- or sodium-containing species selected from Li₂CO₃, Li₂O, Li₂C₂O4, LiOH, LiX, ROCO₂Li, HCOLi, ROLi, (ROCO₂Li)₂, (CH₂OCO₂Li)₂, Li₂S, LiₓSO_{y}, Na₂CO₃, Na₂O, Na₂C₂O₄, NaOH, NaiX, ROCO₂Na, HCONa, RONa, (ROCO₂Na)₂, (CH₂OCO₂Na)₂, Na₂S, NaₓSO_{y}, or a combination thereof, wherein X=F, Cl, I, or Br, R=a hydrocarbon group, x=0-1, y=1-4.

4. The lithium-ion battery of claim 1, wherein said artificial SEI layer comprises a matrix of amorphous carbon, polymeric carbon, or a polymer, and from 0% to 50% by weight of a reinforcement phase dispersed in said matrix, and a lithium- or sodium-containing species that are chemically bonded to or dispersed in said matrix and/or said reinforcement phase to form an integral layer, wherein said lithium- or sodium-containing species is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, Na₂CO₃, Na₂O, Na₂C₂O₄, NaOH, NaiX, ROCO₂Na, HCONa, RONa, (ROCO₂Na)₂, (CH₂OCO₂Na)₂, Na₂S, NaₓSO_{y}, or a combination thereof, wherein X=F, Cl, I, or Br, R=a hydrocarbon group, x=0-1, y=1-4; and wherein said lithium- or sodium-containing species is derived from an electrochemical decomposition reaction, wherein the matrix is from 5% to 95% by volume of the integral layer if said reinforcement phase is present, and wherein a weight ratio of the matrix to the lithium- or sodium-containing species is from 1/100 to 100/1.

5. The lithium-ion battery of claim 1, wherein said artificial SEI layer comprises a product of electrochemical reductive or oxidative degradation of an electrolyte.

6. The lithium-ion battery of claim 1, wherein the conductive additive contains a material selected from carbon particles, expanded graphite flakes, carbon black particles, carbon nanotubes, carbon nano-fibers, carbon fibers, graphite fibers, conductive polymer fibers, coke particles, meso-phase carbon particles, meso-porous carbon particles, electro-spun nano fibers, carbon-coated metal nanowires, conductive polymer-coated nanowires or nano-fibers, graphene sheets or platelets, or a combination thereof.

7. The lithium-ion battery of claim 4, wherein the reinforcement phase contains a material selected from ceramic particles or fibers, glass particles or fibers, carbon particles, expanded graphite flakes, carbon black particles, carbon nanotubes, carbon nano-fibers, carbon fibers, graphite fibers, polymer fibers, coke particles, meso-phase carbon particles, meso-porous carbon particles, electro-spun nano fibers, carbon-coated metal nanowires, conductive polymer-coated nanowires or nano-fibers, graphene sheets or platelets, or a combination thereof.

8. The lithium-ion battery of claim 6, wherein said graphene sheets or platelets include single-layer sheets or multi-layer platelets of a graphene material selected from pristine graphene, graphene oxide having 2% to 46% by weight of oxygen, reduced graphene oxide having 0.01% to 2% by weight of oxygen, chemically functionalized graphene, nitrogen-doped graphene, boron-doped graphene, fluorinated graphene, or a combination thereof.

9. The lithium-ion battery of claim 1, wherein said anode contains less than 1% by weight of the binder resin and/or less than 5% by weight of the conductive additive.

10. The lithium-ion battery of claim 1, wherein the separator comprises a porous polymer or polymer membrane, a fabric, a solid polymer electrolyte, an inorganic solid electrolyte, or a combination thereof.

11. The lithium-ion battery of claim 10, wherein the inorganic solid electrolyte is selected from an oxide type, Perovskite, sulfide type, Argyrodite, hydride type, halide type, borate type, phosphate type, lithium phosphorus oxynitride (UPON), garnet--type, lithium superionic conductor (LISICON) type, sodium superionic conductor (NASICON) type, or a combination thereof.

12. The lithium-ion battery of claim 10, wherein the solid polymer electrolyte is selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

13. The lithium-ion battery of claim 10, wherein the porous polymer or the solid polymer electrolyte is further soaked or impregnated with a liquid electrolyte comprising a lithium salt dissolved in a liquid solvent.

14. The lithium-ion battery of claim 1, wherein the anode contains 0%-5% by weight of a binder resin or contains 0.1%-5% by weight of a conductive additive.

15. The lithium-ion battery of claim 1, wherein said anode contains multiple pores having a pore volume of 10-75% based on the total anode volume.

16. The lithium-ion battery of claim 7, wherein the ceramic particles or fibers are selected from a metal oxide, metal carbide, metal nitride, metal boride, metal dichalcogenide, or a combination thereof.

17. The lithium-ion battery of claim 1, wherein said artificial SEI layer has a thickness from 10 nm to 20 μm.

18. A method for producing the artificial solid-electrolyte interface (SEI) layer of claim 1, said method comprising (a) preparing a working electrode containing a structure of said amorphous carbon, polymeric carbon, or polymer matrix and a reinforcement phase dispersed in said matrix; (b) preparing a counter electrode containing lithium or sodium metal or alloy; (c) bringing said working electrode and said counter electrode in contact with an electrolyte containing a solvent and a lithium salt or sodium salt dissolved in said solvent;
and (d) applying a current or voltage to said working electrode and said counter electrode to induce an electrochemical oxidative decomposition and/or a reductive decomposition of said electrolyte and/or said salt for forming said lithium- or sodium-containing species that are chemically bonded to said matrix and/or said reinforcement phase to produce said artificial SEI layer.

19. The method of claim 18, wherein said lithium salt or sodium salt is selected from lithium perchlorate, LiClO₄, lithium hexafluorophosphate, LiPF₆, lithium borofluoride, LiBF₄, lithium hexafluoroarsenide, LiAsF₆, lithium trifluoro-metasulfonate, LiCF₃SO₃, bis-trifluoromethyl sulfonylimide lithium, LiN(CF₃SO₂)₂, lithium bis(oxalato)borate, LiBOB, lithium oxalyldifluoroborate, LiBF₂C₂O₄, lithium oxalyldifluoroborate, LiBF₂C₂O₄, lithium nitrate, LiNO₃, Li-Fluoroalkyl-Phosphates, LiPF₃(CF₂CF₃)₃, lithium bisperfluoro-ethysulfonylimide, LiBETI, lithium bis(trifluoromethanesulphonyl)imide, lithium bis(fluorosulphonyl)imide, lithium trifluoromethanesulfonimide, LiTFSI, an ionic liquid-based lithium salt, sodium perchlorate, NaClO₄, sodium hexafluorophosphate, NaPF₆, sodium borofluoride, NaBF₄, sodium hexafluoroarsenide, sodium trifluoro-metasulfonate, NaCF₃SO₃, bis-trifluoromethyl sulfonylimide sodium, NaN(CF₃SO₂)₂, sodium trifluoromethanesulfonimide, NaTFSI, bis-trifluoromethyl sulfonylimide sodium, NaN(CF₃SO₂)₂, or a combination thereof.

20. The method of claim 18, wherein said solvent is selected from 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a hydrofluoroether, an ionic liquid solvent, or a combination thereof.

21. The method of claim 18, which is a roll-to-roll process that includes preparing said working electrode in a roll form supported by a feeder roller, and said step of bringing said working electrode and said counter electrode in contact with said electrolyte contains unwinding said working electrode from said feeder roller, and feeding said working electrode into said electrolyte.

22. A method for producing the artificial SEI layer of claim 1, said method comprising (a) preparing a working electrode containing a porous structure of said matrix and a reinforcement phase; (b) preparing a counter electrode containing lithium or sodium metal or alloy; and (c) bringing said working electrode and said counter electrode in physical or ionic contact with each other and in contact with an electrolyte containing a solvent and a lithium salt or sodium salt dissolved in said solvent; wherein said working electrode and said counter electrode are brought to be at the same electrochemical potential level, inducing a chemical reaction between said lithium or sodium metal or alloy and said amorphous carbon or polymeric carbon matrix and/or said reinforcement phase and inducing electrochemical decomposition of said electrolyte for forming said lithium- or sodium-containing species that are chemically bonded to said matrix and/or said reinforcement phase to produce said artificial SEI layer either outside of or inside an intended rechargeable lithium-ion battery.

23. The method of claim 22, which is conducted in a roll-to-roll manner outside of said intended rechargeable alkali metal battery.

24. A method of producing the lithium-ion battery of claim 1, said method comprising:
(a) preparing a lithium-ion battery cell comprising (i) an anode layer, (ii) a precursor or supporting layer of sulfide, hydride, halide, borate, phosphate, amorphous carbon, polymeric carbon, or polymer matrix, (iii) a solid-state electrolyte, different in composition than the precursor or supporting layer, or a porous separator layer and a second electrolyte, and (iv) a cathode layer, wherein said precursor or supporting layer of sulfide, hydride, halide, borate, phosphate, amorphous carbon, polymeric carbon, or polymer matrix is laminated between said anode layer and said porous separator or solid-state electrolyte layer, and said porous separator or solid-state electrolyte layer is disposed between said precursor or supporting layer and said cathode layer; and
(b) subjecting said battery cell to a voltage/current treatment that induces electrochemical reductive and/or oxidative decomposition of said solid-state electrolyte, second electrolyte, sulfide, hydride, halide, borate or phosphate, to form said lithium- and/or sodium-containing species that are bonded to said amorphous carbon, polymeric carbon, or polymer matrix or bonded to the anode, the solid-state electrolyte, or the separator layer to form the artificial SEI layer in said battery cell to obtain said lithium-ion battery.

25. The method of claim 24, wherein said step (a) of preparing a lithium-ion battery cell comprises depositing sulfide, hydride, halide, borate, phosphate, amorphous carbon, polymeric carbon, or a polymer matrix onto said porous separator or solid-state electrolyte layer or said anode layer to form a layer up to a thickness from 10 nm to 20 μm.

26. The method of claim 24, wherein the second electrolyte or an electrolyte to be included in the cathode layer is selected from a solid polymer electrolyte, polymer gel electrolyte, composite electrolyte, ionic liquid electrolyte, non-aqueous liquid electrolyte, soft matter phase electrolyte, inorganic solid-state electrolyte, or a combination thereof.
